(19) United States
(12) Patent Application Publication
(10) Pub. No.: US 2008/0004970 A1
(43) Pub. Date: Jan. 3, 2008

(54) Method for customized objective predetermined organized selling

(75) Inventors: Michael J. Ehrensberger, Cincinnati, OH (US); Allen D. Hoffman, Miami, FL (US)

Correspondence Address: GALLAGHER & DAWSEY CO., L.P.A., P.O. BOX 785, COLUMBUS, OH, 43216, US

(73) Assignee: Sales Force Systems, LLC

(21) Appl. No.: 11/455,044

(22) Filed: Jun. 16, 2006

(51) Int. Cl. G06Q 30/00

(52) U.S. Cl. 705/26

(57) ABSTRACT

A method for customized objective predetermined organized selling of products and services is provided. In one embodiment, the method includes a progressive sales guide with a sales evaluation guide and a sales improvement guide. The progressive sales guide may have at least one stage. Each stage may have a stage status for determining when the stage is complete. The stages may have a stage task list comprised of at least one stage required action. Completion of the sales improvement guide and the sales evaluation guide may help a salesperson complete the stage required actions of the stage task list. The sales evaluation guide may have a predetermined sales evaluation criterion. The salesperson may select a stage response from a primary stage ranking and a secondary stage ranking according to the predetermined sales evaluation criterion. The sales improvement guide provides at least one stage improvement objective for the salesperson to perform.

### TECHNICAL FIELD

The present invention relates to the field of selling products and services to prospective customers, and, more particularly, to a method for selling products based on objective predetermined criteria organized in one or more stages.

### BACKGROUND OF THE INVENTION

Many organizations would agree that they compete in a global economy. The organization may be a company, a limited liability company, a sole proprietorship, or another legal form for carrying on business. Quarter-to-quarter survival has become a norm. More organizations with a variety of innovative products and services compete head-to-head in a fast-paced marketplace in an attempt to maintain or improve their bottom lines. Organizations are continually striving to create an edge, or advantage, over their competitors to garner more market share. Many times organizations that have knowledgeable, skilled salespeople dominate their markets. Their salespeople give them the edge over their competition. Quite often, however, skilled salespeople are an exception rather than a rule, and due to the demand for these people, they migrate between organizations making it difficult for organizations to take command of any particular market for any extended period. To combat loss of skilled salespeople and to improve the overall quality of their salespeople, organizations have developed comprehensive training systems. Continuous training of new and veteran salespeople alike has become essential for survival in the present business environment.

Even while training salespeople has become a normal operating expense, the skills developed during training often do not seem to appreciably impact the organization's sales. Probably the largest contribution to sales failing to meet expectations is salespeople not adhering to a selling methodology or structure. Lack of structured selling many times is endemic within an organization. Each salesperson may have their own procedure for selling the organization's products or services. Most often, it is therefore difficult for the organization to assess each salesperson's performance, other than by determining if the salesperson has met their sales quotas. The problem with quotas is that they do not provide any information on the status or probability of the salesperson successfully generating sales from any one customer—the status remains a mystery until the sale is won or, more often, lost. To complicate matters, the salespeople are unable to offer much quantitative analysis of their odds of winning a prospective customer. Frequently, the salesperson's analysis is a mixture of personal emotions rather than an evaluation of the odds of winning based on an objective evaluation of predetermined criteria. Of course, salespeople not adhering to a selling methodology can cause other problems.

For instance, by not using a structural approach to selling, the organization limits comprehensive implementation of its best practices. One salesperson may develop a new approach to selling a particular product line. However, without a selling structure in place, propagating these new approaches throughout the sales force is, at best, problematic. In addition to difficulties with implementation of best practices, organizations have difficulty with repeatable sales performance.

The organization many times does not have repeatability from one prospective customer to the next. Each individual salesperson may use their own techniques resulting in chaotic, haphazard selling success. In turn, the poor repeatability prohibits the organization from accurately assessing their sales productivity and probability. Inaccurate sales forecasting is the inevitable result. Moreover, in the event that the salesperson leaves their position, whether by a promotion, moving to a different geographic region, or leaving the organization for “greener pastures,” the organization may not be able to capture those more effective methods.

Another problem with salespeople lacking selling methodology is that the salespeople generally have longer sales cycles. If the salespeople have multiple prospective customers, which is normal with organizations trying to keep expenses down, the progress at any particular prospective customer may not be immediately ascertainable and proceeds on an undefined timeline. In other situations, the prospective customer is forgotten during periods of great activity at another prospective customer. During any intermission in contact from the salesperson, competitors may gain an upper hand with respect to the forgotten prospective customer. Poor selling methodology is even more problematic when high capital cost products are being sold.

Many high capital cost products and services have long lead times leaving more opportunities for salespeople to lose prospective customers. Prospective customers are slow to consummate high capital cost purchases. They take their time to evaluate other options, to evaluate long term performance of any potential purchase, and to evaluate the return on investment of their purchase. For them, failure to select the most appropriate product may have dire, even catastrophic, consequences. However, from the perspective of the salespeople, making the sale is vital to their organization's survival as only a small number of sales may be made from one quarter to the next. Understandably then, the competition in selling high capital cost goods and services is extraordinarily intense, thus, having an edge may be “the” deciding factor. In this situation, continuous evaluation of the prospective customer, and the organization's competition, is necessary to create that edge.

There remains an unfulfilled need for a method of selling products and services that provides continuous objective evaluation of the probability of winning sales with the prospective customer by using predetermined criteria, organized into successive stages. In addition, there remains an unfulfilled need for a method of selling that may incorporate the organization's best selling methods, thereby providing a tool to give the organization the edge they need to compete and win sales in a competitive marketplace.

### SUMMARY OF INVENTION

The present invention advances the state of the art with a variety of new capabilities and overcomes many of the shortcomings of prior methods in new and novel ways. The present invention overcomes the shortcomings and limitations of the prior art in any of a number of generally effective configurations. The instant invention demonstrates such capabilities and overcomes many of the shortcomings of prior methods in new and novel ways.

The method for customized objective predetermined organized selling of products to a prospective customer comprises multiple, predetermined stages where each stage may incorporate one or more guides that contain predetermined evaluation criteria. A goal of using the method is to turn prospective customers into customers. In one embodiment, the method comprises initiating a progressive sales guide comprised of a sales evaluation guide and a sales improvement guide.

After an initial contact with a prospective customer, a salesperson initiates the progressive sales guide by beginning at an initial stage for the prospective customer. The initial stage includes a task list with at least one initial stage required action. An initial stage status may be evaluated by determining whether each of the initial stage required actions is complete. The initial stage status may be complete or incomplete.

Completion of the initial stage may begin with the salesperson first addressing the initial stage required actions. The initial stage required actions may include phrases describing actions for the salesperson to complete. While completing the initial stage task list may be possible during the initial contact with the prospective customer, many times completing the initial stage task list may not be possible following limited contact with the prospective customer.

When the initial stage status is incomplete, because one initial stage required action is incomplete, the salesperson commences the sales evaluation guide. The sales evaluation guide has at least one predetermined sales evaluation criterion. For each predetermined sales evaluation criterion there may be at least one primary initial stage ranking and at least one secondary initial stage ranking. The salesperson selects an initial stage response from either the primary initial stage ranking or the secondary initial stage ranking. The sales improvement guide may provide at least one initial stage improvement objective. The initial stage improvement objective may be related to the initial stage response. In one embodiment, the initial stage improvement objective may include the organization's best practices for improving the probability of winning the sale.

In one embodiment of the instant invention, by completing the initial stage improvement objective the salesperson may complete at least one of the incomplete initial stage required actions. Following completion of the initial stage improvement objective, the initial stage task list may be reviewed. When the initial stage required action is completed, the initial stage status is complete and a second stage of the progressive sales guide may be fully addressed.

The salesperson fully addresses the second stage after determining that the initial stage status is complete. Like the initial stage, the second stage may have a second stage status and a second stage task list. The second stage task list, in turn, may have at least one second stage required action. As one skilled in the art will observe and appreciate, one or more second stage required actions may be completed during the first stage. However, the initial stage may be completed only by completing each initial stage required action.

After determining that the second stage status is incomplete, by verifying if one second stage required action is incomplete, the salesperson proceeds to the sales evaluation guide. The salesperson updates the sales evaluation guide by selecting a second stage response to the predetermined sales evaluation criterion. The second stage response may be selected from a primary second stage ranking and a secondary second stage ranking.

Following selection of the second stage response, the salesperson completes the sales improvement guide. As before, the sales improvement guide may have at least one second stage improvement objective. The second stage improvement objective may be related to the second stage response.

In another embodiment of the present invention, the step of completing the sales improvement guide may also include completing a decision making hierarchy evaluation guide. The decision making hierarchy evaluation guide may help the salesperson organize and identify at least one decision maker at the prospective customer that may be responsible for making a decision to purchase the product.

In another embodiment of the instant invention, the sales improvement guide further includes a competition evaluation guide for evaluating the competitor's offering, for evaluating the salesperson's organization's offering, and for evaluating the prospective customer's purchasing criteria. The competition evaluation guide may provide a framework for assessing the competition at the prospective customer in a predetermined, objective fashion.

The method of the instant invention enables a significant advance in the state of the art. The instant invention is, in addition, widely applicable to a large number of applications. Variations, modifications, alternatives, and alterations of the various preferred embodiments may be used alone or in combination with one another, as will become more readily apparent to those with skill in the art with reference to the following detailed description of the preferred embodiments and the accompanying figures and drawings.

### BRIEF DESCRIPTION OF THE DRAWINGS

Without limiting the scope of the present invention as claimed below and referring now to the drawings and FIGS:

FIG. 1 is a flow diagram of an embodiment of the present invention showing a first stage of a progressive sales guide;

FIG. 2 is a table of a plurality of initial stage required actions in an initial stage task list of an embodiment of the present invention;

FIG. 3 is an embodiment of a sales evaluation guide of the present invention showing a primary initial stage ranking and a secondary initial stage ranking for a predetermined sales evaluation criterion;

FIG. 4 is an embodiment of a sales improvement guide of the present invention showing an initial stage response with a plurality of initial stage improvement objectives;

FIG. 5 is an embodiment of the sales improvement guide of the present invention showing the initial stage response with a plurality of initial stage improvement objectives;

FIG. 6 is a flow diagram of an embodiment of the present invention showing a second stage of the progressive sales guide;

FIG. 7 is a flow diagram of an embodiment of the present invention showing the sales improvement guide having a decision making hierarchy evaluation guide;

FIG. 8 is a diagram of an embodiment of the decision making hierarchy evaluation guide having a plurality of decision makers;

FIG. 9 is a flow diagram of an embodiment of the present invention showing the sales improvement guide having a competition evaluation guide;

FIG. 10 is a table of a plurality of predetermined competitive evaluation criterion of an embodiment of the sales improvement guide having a competition evaluation guide;

FIG. 11 is an embodiment of a predetermined evaluation criterion with a plurality of primary initial stage rankings and a plurality of secondary initial stage rankings;

FIG. 12 is a diagram of an embodiment of the initial stage response selected from the predetermined evaluation criterion, as seen in FIG. 11, with a plurality of initial stage improvement objectives;

FIG. 13 is a diagram of an embodiment of the initial stage response selected from the predetermined evaluation criterion, as seen in FIG. 1, with the initial stage improvement objectives;

FIG. 14 is a diagram of an embodiment of the initial stage response selected from the predetermined evaluation criterion, as seen in FIG. 1, with the initial stage improvement objectives;

FIG. 15 is an embodiment of the predetermined evaluation criterion with the primary initial stage rankings and the secondary initial stage rankings;

FIG. 16 is a diagram of an embodiment of the initial stage response selected from the primary initial stage rankings and the secondary initial stage rankings, as seen in FIG. 15, with the initial stage improvement objectives;

FIG. 17 is a diagram of an embodiment of the initial stage response selected from the primary initial stage rankings and the secondary initial stage rankings, as seen in FIG. 15, with the initial stage improvement objectives;

FIG. 18 is a diagram of an embodiment of the initial stage response selected from the primary initial stage rankings and the secondary initial stage rankings, as seen in FIG. 15, with the initial stage improvement objectives;

FIG. 19 is a diagram of an embodiment of the initial stage response selected from the primary initial stage rankings and the secondary initial stage rankings, as seen in FIG. 15, with the initial stage improvement objectives;

FIG. 20 is an embodiment of the predetermined evaluation criterion with the primary initial stage rankings and the secondary initial stage rankings;

FIG. 21 is a diagram of an embodiment of the initial stage response selected from the primary initial stage rankings and the secondary initial stage rankings, as seen in FIG. 20, with the initial stage improvement objectives;

FIG. 22 is a diagram of an embodiment of the initial stage response selected from the primary initial stage rankings and the secondary initial stage rankings, as seen in FIG. 20, with the initial stage improvement objectives;

FIG. 23 is a diagram of an embodiment of the initial stage response selected from the primary initial stage rankings and the secondary initial stage rankings, as seen in FIG. 20, with the initial stage improvement objectives;

FIG. 24 is a diagram of an embodiment of the initial stage response selected from the primary initial stage rankings and the secondary initial stage rankings, as seen in FIG. 20, with the initial stage improvement objectives;

FIG. 25 is a diagram of an embodiment of the initial stage response selected from the primary initial stage rankings and the secondary initial stage rankings, as seen in FIG. 20, with the initial stage improvement objectives;

FIG. 26 is an embodiment of the predetermined evaluation criterion with the primary initial stage rankings and the secondary initial stage rankings;

FIG. 27 is a diagram of an embodiment of the initial stage response selected from the primary initial stage rankings and the secondary initial stage rankings, as seen in FIG. 26, with the initial stage improvement objectives;

FIG. 28 is a diagram of an embodiment of the initial stage response selected from the primary initial stage rankings and the secondary initial stage rankings, as seen in FIG. 26, with the initial stage improvement objectives;

FIG. 29 is a diagram of an embodiment of the initial stage response selected from the primary initial stage rankings and the secondary initial stage rankings, as seen in FIG. 26, with the initial stage improvement objectives;

FIG. 30 is a diagram of an embodiment of the initial stage response selected from the primary initial stage rankings and the secondary initial stage rankings, as seen in FIG. 26, with the initial stage improvement objectives;

FIG. 31 is an embodiment of the predetermined evaluation criterion with the primary initial stage rankings and the secondary initial stage rankings;

FIG. 32 is a diagram of an embodiment of the initial stage response selected from the primary initial stage rankings and the secondary initial stage rankings, as seen in FIG. 31, with the initial stage improvement objectives;

FIG. 33 is a diagram of an embodiment of the initial stage response selected from the primary initial stage rankings and the secondary initial stage rankings, as seen in FIG. 31, with the initial stage improvement objectives;

FIG. 34 is a diagram of an embodiment of the initial stage response selected from the primary initial stage rankings and the secondary initial stage rankings, as seen in FIG. 31, with the initial stage improvement objectives;

FIG. 35 is a diagram of an embodiment of the initial stage response selected from the primary initial stage rankings and the secondary initial stage rankings, as seen in FIG. 31, with the initial stage improvement objectives;

FIG. 36 is a diagram of an embodiment of the initial stage response selected from the primary initial stage rankings and the secondary initial stage rankings, as seen in FIG. 31, with the initial stage improvement objectives;

FIG. 37 is an embodiment of the predetermined evaluation criterion with the primary initial stage rankings and the secondary initial stage rankings;

FIG. 38 is a diagram of an embodiment of the initial stage response selected from the primary initial stage rankings and the secondary initial stage rankings, as seen in FIG. 37, with the initial stage improvement objectives;

FIG. 39 is a diagram of an embodiment of the initial stage response selected from the primary initial stage rankings and the secondary initial stage rankings, as seen in FIG. 37, with the initial stage improvement objectives;

FIG. 40 is a diagram of an embodiment of the initial stage response selected from the primary initial stage rankings and the secondary initial stage rankings, as seen in FIG. 37, with the initial stage improvement objectives;

FIG. 41 is a diagram of an embodiment of the initial stage response selected from the primary initial stage rankings and the secondary initial stage rankings, as seen in FIG. 37, with the initial stage improvement objectives;

FIG. 42 is a diagram of an embodiment of the initial stage response selected from the primary initial stage rankings and the secondary initial stage rankings, as seen in FIG. 37, with the initial stage improvement objectives;

FIG. 43 is an embodiment of the predetermined evaluation criterion with the primary initial stage rankings and the secondary initial stage rankings;

FIG. 44 is a diagram of an embodiment of the initial stage response selected from the primary initial stage rankings and the secondary initial stage rankings, as seen in FIG. 43, with the initial stage improvement objectives;

FIG. 45 is a diagram of an embodiment of the initial stage response selected from the primary initial stage rankings and the secondary initial stage rankings, as seen in FIG. 43, with the initial stage improvement objectives;

FIG. 46 is a diagram of an embodiment of the initial stage response selected from the primary initial stage rankings and the secondary initial stage rankings, as seen in FIG. 43, with the initial stage improvement objectives;

FIG. 47 is a diagram of an embodiment of the initial stage response selected from the primary initial stage rankings and the secondary initial stage rankings, as seen in FIG. 43, with the initial stage improvement objectives;

FIG. 48 is a diagram of an embodiment of the initial stage response selected from the primary initial stage rankings and the secondary initial stage rankings, as seen in FIG. 43, with the initial stage improvement objectives;

FIG. 49 is an embodiment of the predetermined evaluation criterion with the primary initial stage rankings and the secondary initial stage rankings;

FIG. 50 is a diagram of an embodiment of the initial stage response selected from the primary initial stage rankings and the secondary initial stage rankings, as seen in FIG. 49, with the initial stage improvement objectives;

FIG. 51 is a diagram of an embodiment of the initial stage response selected from the primary initial stage rankings and the secondary initial stage rankings, as seen in FIG. 49, with the initial stage improvement objectives;

FIG. 52 is a diagram of an embodiment of the initial stage response selected from the primary initial stage rankings and the secondary initial stage rankings, as seen in FIG. 49, with the initial stage improvement objectives;

FIG. 53 is a diagram of an embodiment of the initial stage response selected from the primary initial stage rankings and the secondary initial stage rankings, as seen in FIG. 49, with the initial stage improvement objectives;

FIG. 54 is a diagram of an embodiment of the initial stage response selected from the primary initial stage rankings and the secondary initial stage rankings, as seen in FIG. 49, with the initial stage improvement objectives;

FIG. 55 is an embodiment of the predetermined evaluation criterion with the primary initial stage rankings and the secondary initial stage rankings;

FIG. 56 is a diagram of an embodiment of the initial stage response selected from the primary initial stage rankings and the secondary initial stage rankings, as seen in FIG. 55, with the initial stage improvement objectives;

FIG. 57 is a diagram of an embodiment of the initial stage response selected from the primary initial stage rankings and the secondary initial stage rankings, as seen in FIG. 55, with the initial stage improvement objectives;

FIG. 58 is a diagram of an embodiment of the initial stage response selected from the primary initial stage rankings and the secondary initial stage rankings, as seen in FIG. 55, with the initial stage improvement objectives;

FIG. 59 is a diagram of an embodiment of the initial stage response selected from the primary initial stage rankings and the secondary initial stage rankings, as seen in FIG. 55, with the initial stage improvement objectives;

FIG. 60 is a diagram of an embodiment of the initial stage response selected from the primary initial stage rankings and the secondary initial stage rankings, as seen in FIG. 55, with the initial stage improvement objectives;

FIG. 61 is a table of an embodiment of a second stage task list;

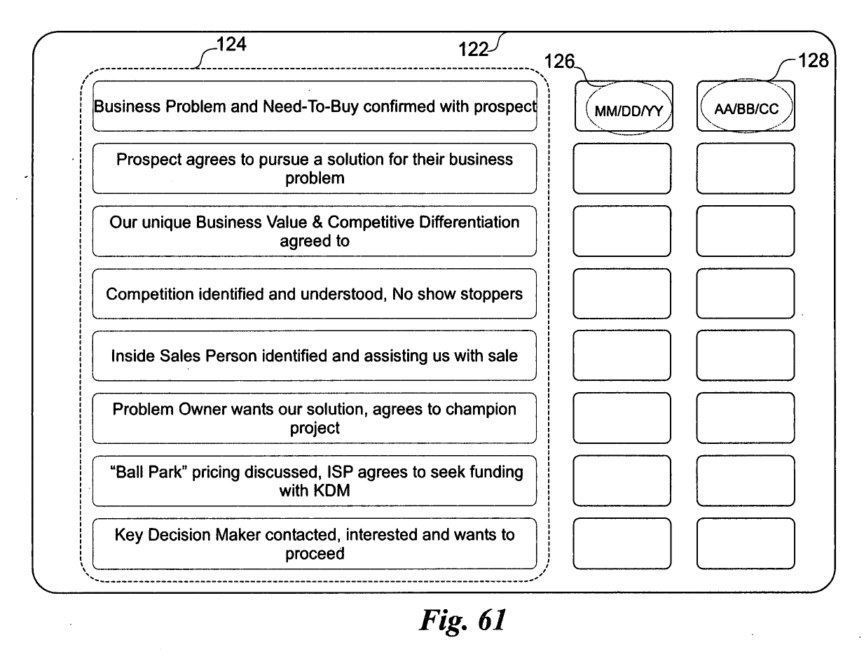

FIG. 62 is a table of an embodiment of a third stage task list;

FIG. 63 is a table of an embodiment of a fourth stage task list;

FIG. 64 is a table of an embodiment of a fifth stage task list; and

FIG. 65 is a table of an embodiment of a sixth stage task list.

### DETAILED DESCRIPTION OF THE INVENTION

The method for customized objective predetermined organized selling (50) of the instant invention enables a significant advance in the state of the art. The preferred embodiments of the method (50) accomplish this by new and novel arrangements of elements that are configured in unique and novel ways and which demonstrate previously unavailable but preferred and desirable capabilities. The detailed description set forth below in connection with the drawings is intended merely as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention.

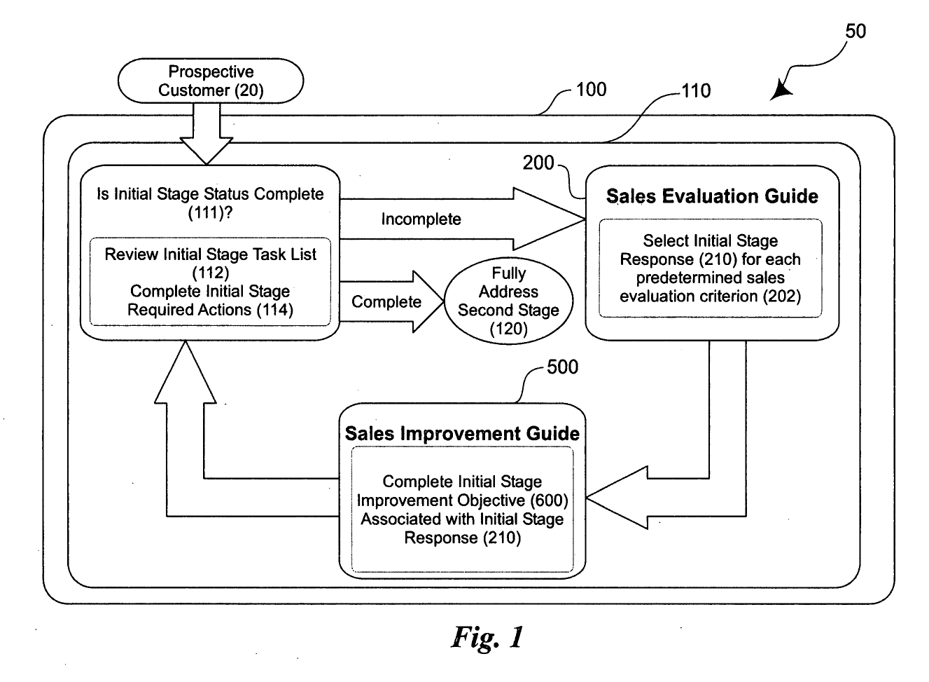

The method for customized objective predetermined organized selling (50) of a product to a prospective customer (20) following an initial contact with the prospective customer (20) may comprise multiple, predetermined, successive stages where each stage may incorporate one or more guides that contain predetermined evaluation criteria. A goal in using the method (50) is to turn the prospective customer (20) into a customer. In one embodiment, as seen in FIG. 1, the method (50) may comprise completing a progressive sales guide (100) which may have stages with each succeeding stage having a sales evaluation guide (200) and a sales improvement guide (500). The method (50) may facilitate selling products to prospective customers (20) by providing an objective framework for implementing an organization's best sales practices. The organization may then guide its salespeople through a core of objective criteria in such a way as to help eliminate the possibility that simple, yet effective, activities are overlooked or forgotten by a salesperson. As one skilled in the art will recognize and appreciate, the method (50) may encompass the selling of services rather than products or goods, or may encompass the selling of a combination service and product to the prospective customer (20).

As seen in FIG. 1, in one embodiment of the instant invention, after initial contact with the prospective customer (20), the salesperson initiates the progressive sales guide (100) by beginning at an initial stage (110) for the prospective customer (20). The initial stage (110) includes a task list (112), the sales evaluation guide (200) and the sales improvement guide (500). The sales evaluation guide (200) and the sales improvement guide (500) will be described in detail later.

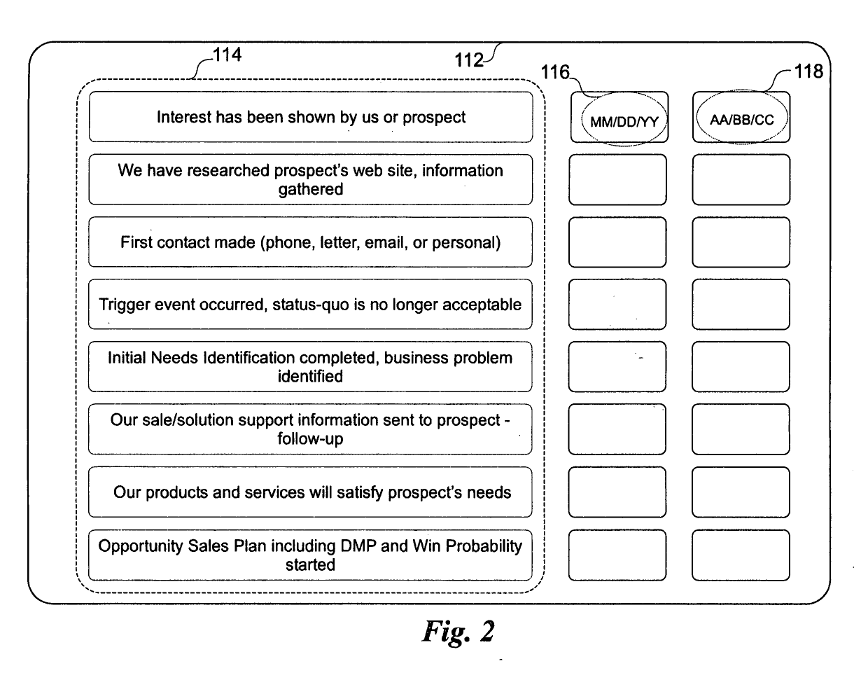

As seen in more detail in FIG. 2, the task list (112) has at least one initial stage required action (114) that must be completed. Each initial stage required action (114) may have an initial stage required action target completion date (116) that is predetermined by the organization. When the initial stage required action (114) is completed, an initial stage required action actual completion date (118) may be entered by the salesperson. By way of example only, perhaps the organization may gauge the salesperson's workload and productivity by comparing the initial stage required action target completion date (116) and initial stage required action actual completion date (118). An initial stage status (111), as seen in FIG. 1, may be determined by assessing whether each initial stage required action (114) is complete. The initial stage status (111) may be complete or incomplete, and the initial stage status (111) may be complete only when each initial stage required action (114), for example, that seen in FIG. 2, is complete.

With continued reference to FIG. 1, completion of the initial stage (110) may begin with the salesperson first addressing the initial stage task list (112). By way of example only, and not limitation, as seen in FIG. 2, in one embodiment of the instant invention, the initial stage required actions (114) may include phrases describing actions for the salesperson to complete. Therefore, for example, when the salesperson completes any of the initial stage required actions (114) then the salesperson may indicate the initial stage required action actual completion date (118) for each initial stage required action (114) completed. It may be possible during the initial contact with the prospective customer (20) to complete the initial stage task list (112), such that the initial stage status (111) is complete. However, many times, completing the initial stage task list (112) may not be possible following limited contact with the prospective customer (20). In one embodiment, the method (50) provides the framework to repeatedly guide the salesperson through the initial stage (110) until the initial stage status (111) is complete. Guidance for completion of the initial stage status (111) may be provided to the salesperson in the sales evaluation guide (200) and in the sales improvement guide (500).

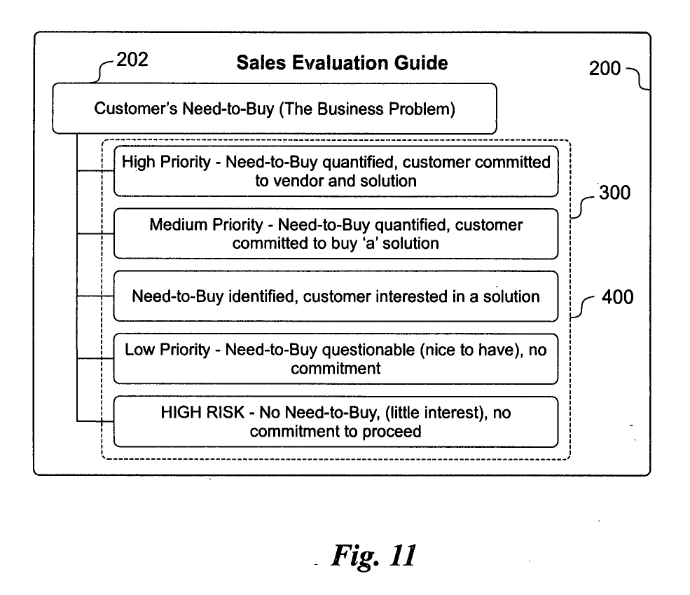

As seen in FIG. 1, in one embodiment of the instant invention, when the initial stage status (111) is incomplete, because one of the initial stage required actions (114) is incomplete, then the salesperson commences the sales evaluation guide (200). The sales evaluation guide (200) has at least one predetermined sales evaluation criterion (202). The predetermined sales evaluation criterion (202) may prompt the salesperson to think critically and make an evaluation of the situation with the prospective customer (20). The sales evaluation guide (200) may help the salesperson evaluate the probability of selling the product to the prospective customer (20). By way of example only, as seen in FIGS. 11, 15, 20, 26, 31, 37, 43, 49, and 55, the sales evaluation guide (200) may have a variety of the predetermined sales evaluation criterion (202). As seen in FIGS. 11, 15, 20, 26, 31, 37, 43, 49, and 55, the predetermined sales evaluation criterion (202) may be any of the following: (A) “Customer's Need-to-Buy (The Business Problem),” (B) “Solution fit (as Perceived by the Customer),” (C) “The Decision-Making Process (DMP),” (D) “Inside Sales-Person (ISP),” (E) “Access to Executive-Level Decision Makers,” (F) “Competitive Awareness,” (G) “Decision Criteria, RFP and Proposal Requirement,” (H) “Funding for this Opportunity,” and (I)“Customer's Buying History.” While the predetermined sales evaluation criterion (202) may be statements such as (A)-(I) above, they serve as statements or questions for analysis and rating by the salespeople. As one skilled in the art will recognize, the specific form and punctuation of the predetermined sales criterion (202) is not important, only that it warrants a ranking.

In an embodiment of the instant invention, the method (50) may allow the organization to customize the initial stage required actions (114) in the initial stage task list (112). Customization may occur, as initial stage required actions (114) may be added, removed, or modified by the organization periodically or as the sales environment changes. In another embodiment of the instant invention, the method (50) may allow the organization to customize the predetermined sales evaluation criterion (202). For example, the organization may tailor the predetermined sales evaluation criterion (202) for each individual line of products or services to incorporate best sales practices for that product or service. In another embodiment, the organization may customize the predetermined sales evaluation criterion (202) according the kind of prospective customer (20), for example, possibly classifying prospective customers (20) by market.

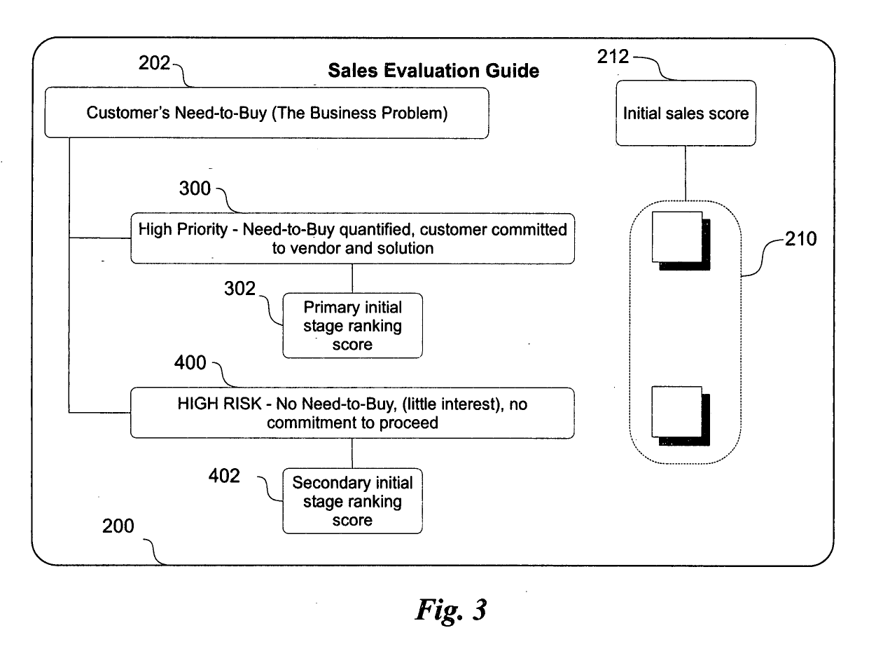

With reference now to FIG. 1, the sales evaluation guide (200) may provide predetermined sales evaluation criterion (202), and the salesperson may select an initial stage response (210) for each of the predetermined sales evaluation criterion (202). As seen in FIG. 3, for each of the predetermined sales evaluation criterion (202) there may be at least one primary initial stage ranking (300) and at least one secondary initial stage ranking (400) for the salesperson to select between. For illustrative purposes, as seen in FIG. 3, the “High Priority—Need-to-Buy quantified, customer committed to vendor and solution” has been identified as the primary initial stage ranking (300) and the “HIGH RISK—No Need-to-Buy, (little interest), no commitment to proceed” has been identified as the secondary initial stage ranking (400).

Thus, the salesperson may select the initial stage response (210) from either the primary initial stage ranking (300) or the secondary initial stage ranking (400) in response to assessing the predetermined sales criterion (202), namely the “customer's need-to-buy.” In one embodiment of the instant invention, the sales evaluation guide (200) may provide one or more sales evaluation criterion (202). By way of example and not limitation, other predetermined sales evaluation criterion (202) can be seen in FIGS. 11, 15, 20, 26, 31, 37, 43, 49, and 55. Other primary initial stage rankings (300) and secondary initial stage rankings (400) are associated with the predetermined sales evaluation criterion (202) and can also be seen in FIGS. 11, 15, 20, 26, 31, 37, 43, 49, and 55.

By way of example and not limitation, as seen in FIG. 11, the predetermined sales evaluation criterion (202) of “Customer's Need-to-Buy (The Business Problem)” may have the primary initial stage ranking (300) of any one or more of the following situationally descriptive titles, such as (A) “High Priority—Need-to-Buy quantified, customer committed to vendor and solution,” (B) “Medium Priority—Need-to-Buy quantified, customer committed to buy ‘a’ solution,” (C) “Need-to-Buy identified, (nice to have), no commitment,” (D) “Low Priority—Need-to-Buy questionable (nice to have), no commitment,” and (E) “HIGH RISK—No Need-to-Buy, (little interest), no commitment to proceed.” The secondary initial stage ranking (400) may also be given one of the aforementioned descriptive titles as long as the secondary initial stage ranking (400) is different from the primary initial stage ranking (300).

In another embodiment of the instant invention, as seen in FIG. 3, the primary initial stage ranking (300) may have a primary initial stage ranking score (302). Likewise, the secondary initial stage ranking (400) may have a secondary initial stage ranking score (402). In another embodiment then, the initial stage response (210) may be given an initial stage sales score (212). The initial stage sales score (212) may be related to the primary initial stage ranking score (302) when the salesperson selects the primary initial stage ranking (300). Alternatively, the initial stage sales score (212) may be related to the secondary initial stage ranking score (402) when the salesperson selects the secondary initial stage ranking (400). In one embodiment of the present invention, the initial sales score (212) is related to a probability of selling the product to the prospective customer (20). In other words, in this embodiment the initial sales score (212) may be expressed as a percentage representing a likelihood of sale success.

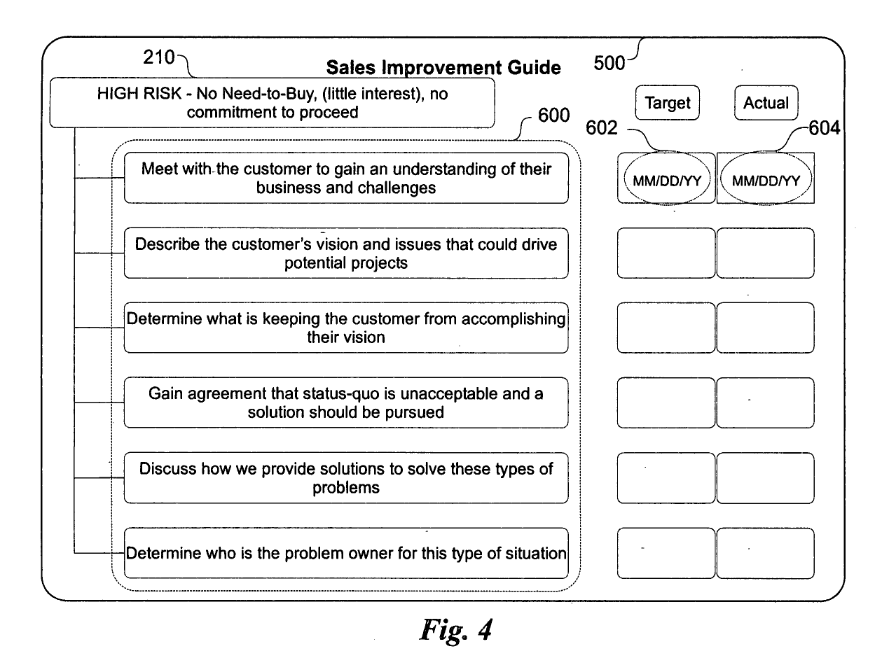

With reference to FIG. 1, once the initial stage response (210) is selected, the sales improvement guide (500) may be evaluated by completing at least one initial stage improvement objective (600). In one embodiment of the instant invention, where the sales evaluation guide (200) provides multiple predetermined sales evaluation criteria (202), the salesperson selects the initial stage response (210) for each predetermined sales evaluation criterion (202). In turn, at least one initial stage improvement objective (600) may be provided for each initial stage response (210). By way of example, and not limitation, as seen in FIG. 4, selection of the primary initial stage ranking (400) of “HIGH RISK—No Need-to-Buy, (little interest), no commitment to proceed” as the initial stage response (210) to the predetermined sales evaluation criterion (202) of “Customer's Need-to-Buy (The Business Problem),” as seen in FIG. 3, may provide the salesperson with the initial stage improvement objectives (600), as seen in FIG. 4, of (A) “Meet with the customer to gain an understanding of their business and challenges,” (B) “Describe the customer's vision and issues that could drive potential projects,” (C) “Determine what is keeping the customer from accomplishing their vision,” (D) “Gain agreement that status-quo is unacceptable and a solution should be pursued,” (E) “Discuss how we provide solutions to solve these types of problems,” or (F) “Determine who is the problem owner for this type of situation.”

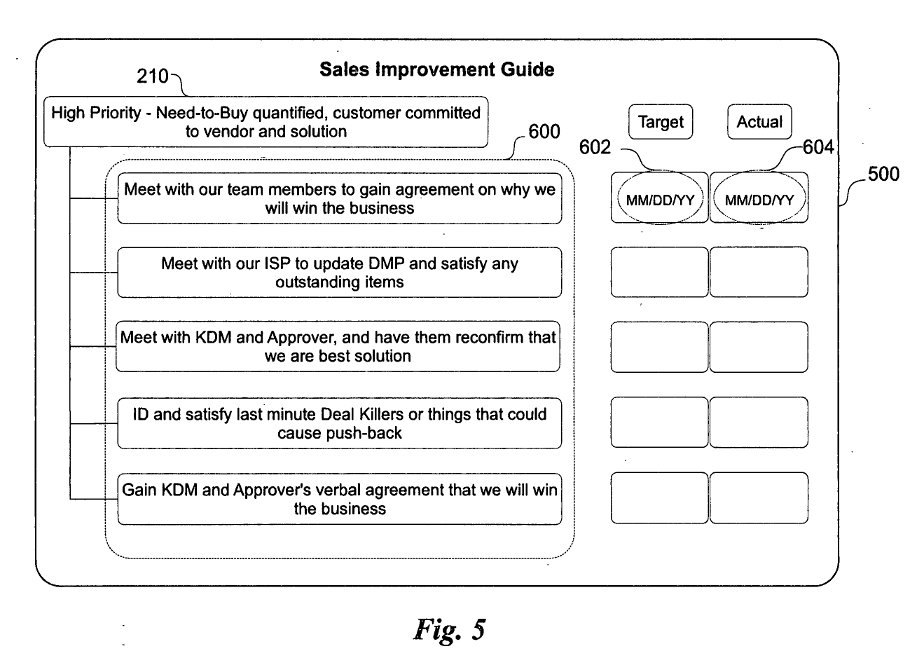

Alternatively, by way of example and not limitation, with reference again to FIGS. 3 and 5, when the salesperson selects the primary initial stage ranking (300) of “High Priority—Need-to-Buy quantified, customer committed to vendor and solution” as the initial stage response (210) to the predetermined sales evaluation criteria (202), then the initial stage improvement objectives (600) may be, as seen in FIG. 5, (A) “Meet with our team members to gain agreement on why we will win the business,” (B) “Meet with our ISP to update DMP and satisfy any outstanding items,” (C) “Meet with KDM and Approver, and have them reconfirm that we are best solution,” (D) “ID and satisfy last minute Deal Killers or things that could cause push-back,” or (E) “Gain KDM and Approver's verbal agreement that we will win the business.”

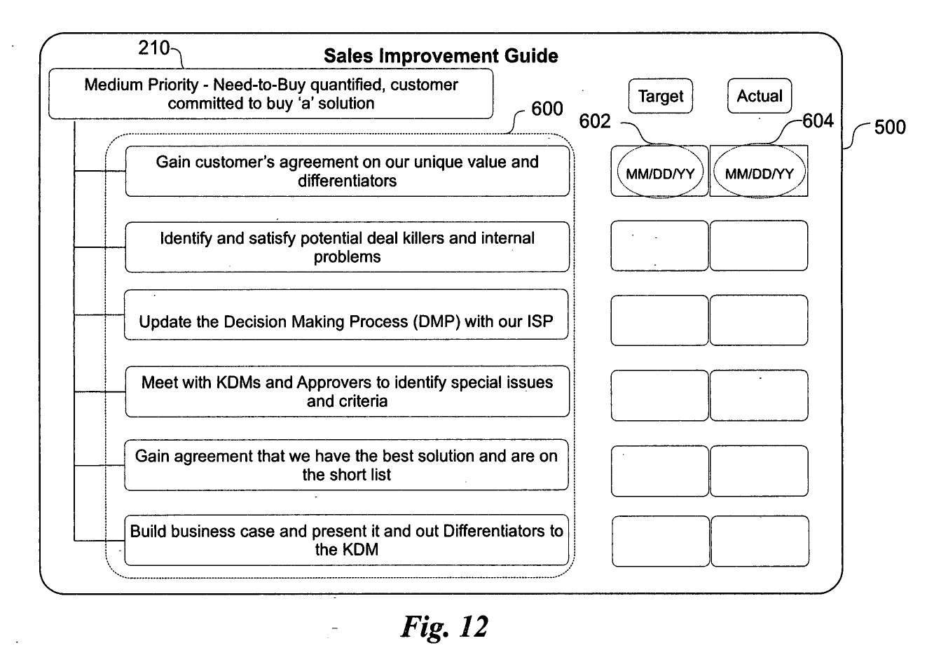

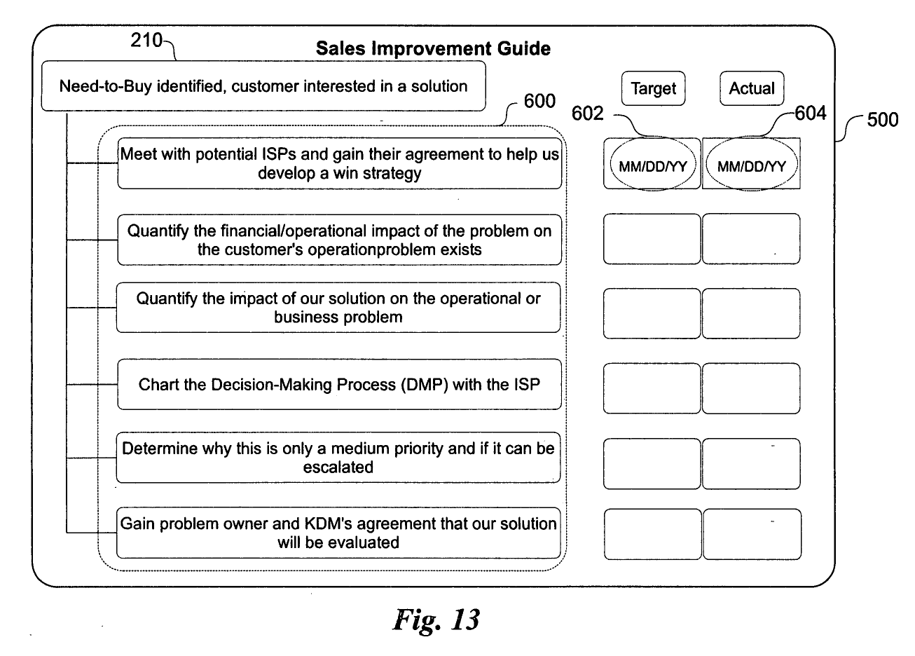

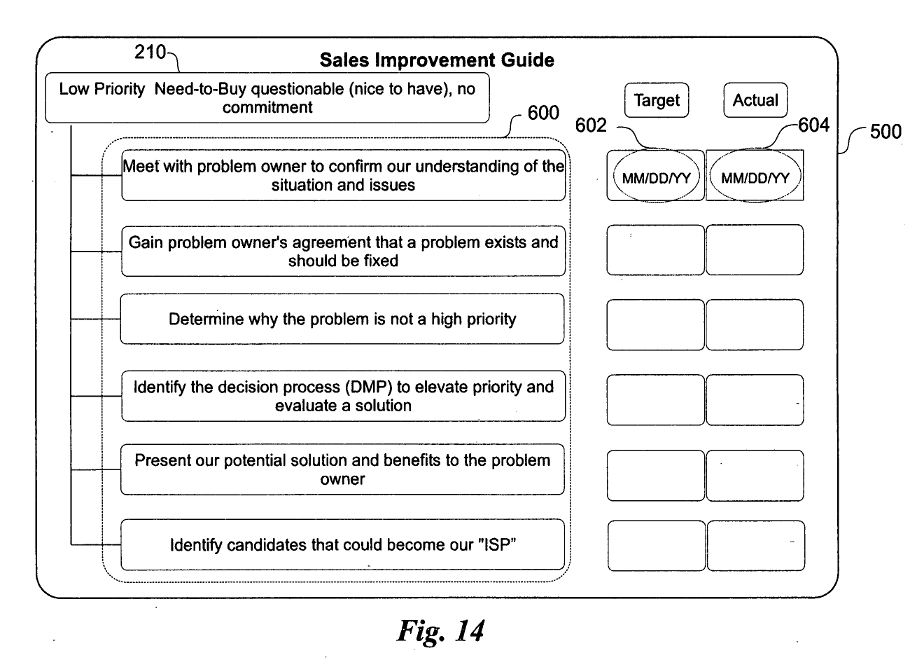

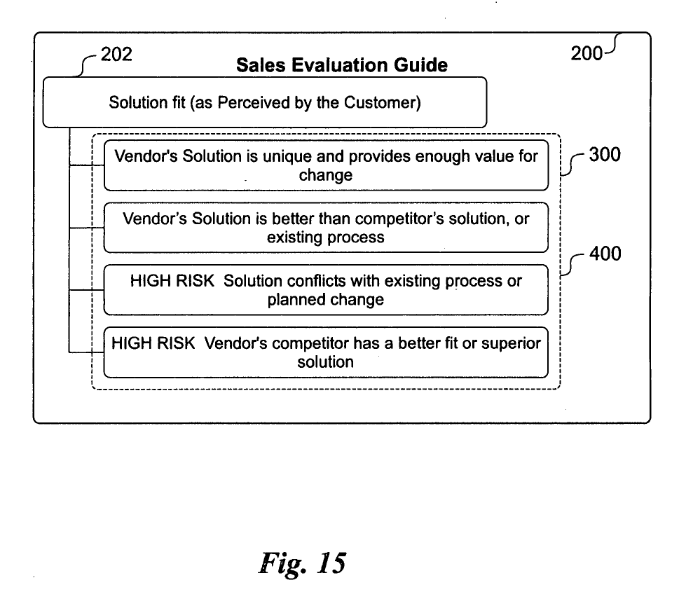

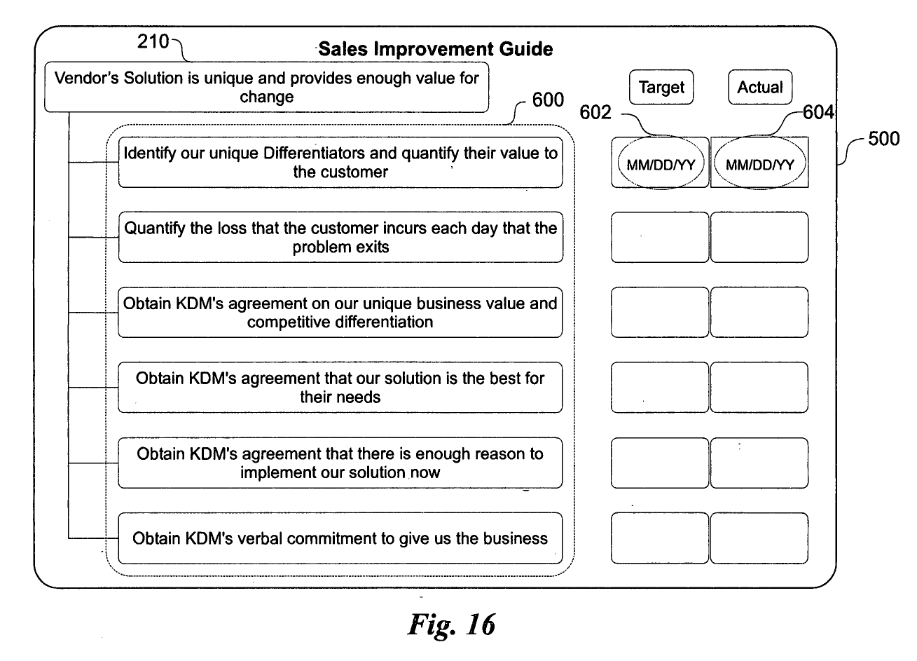

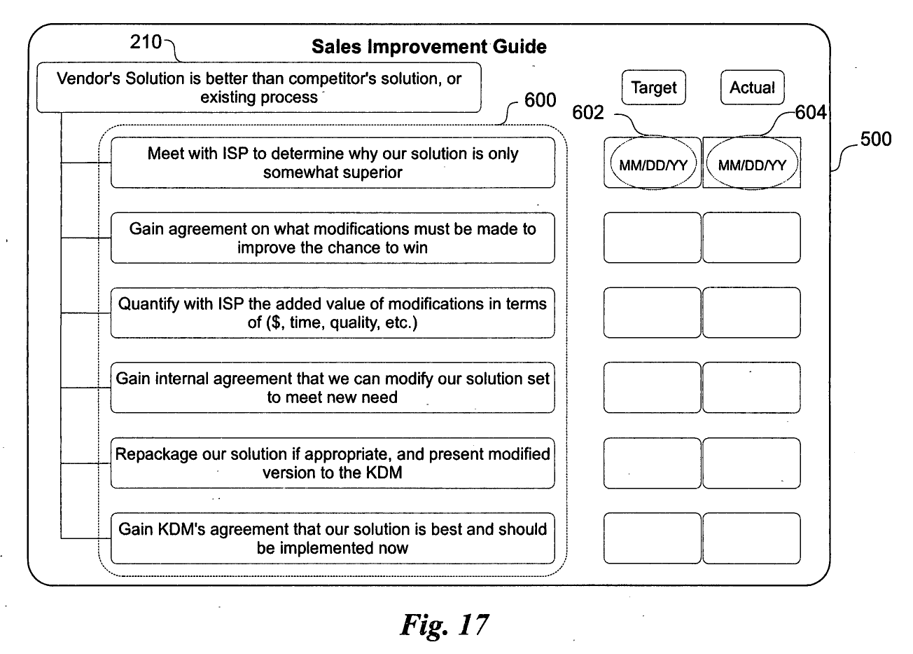

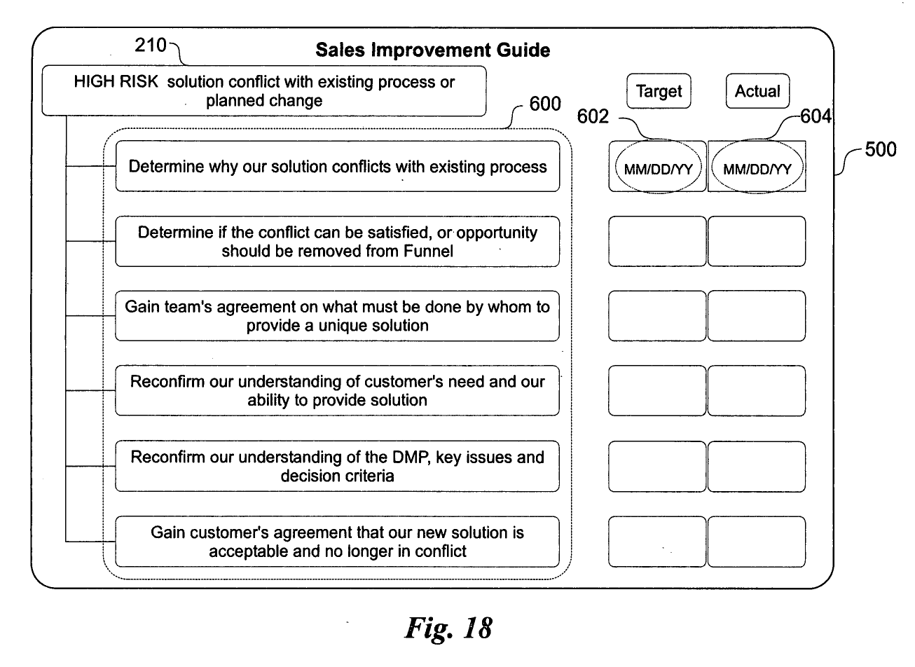

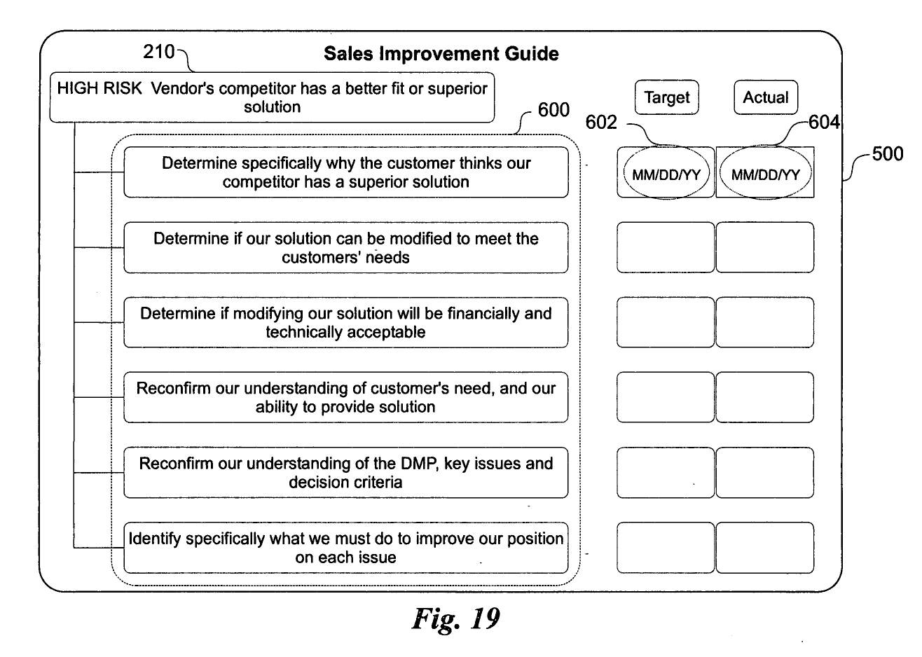

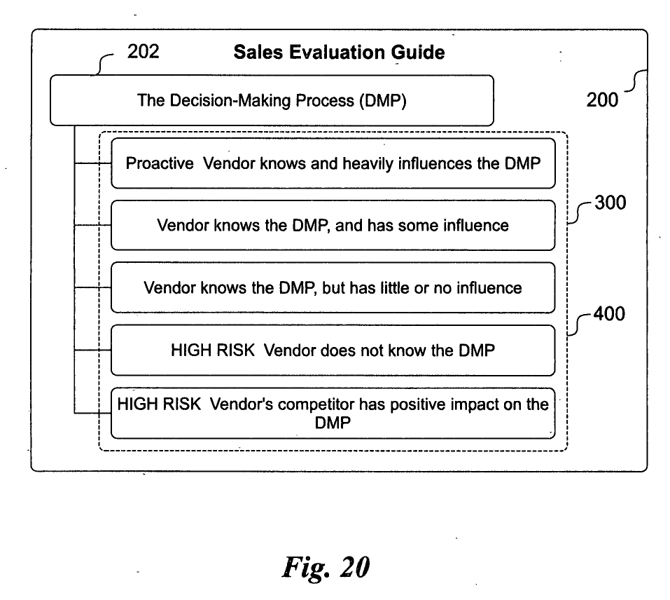

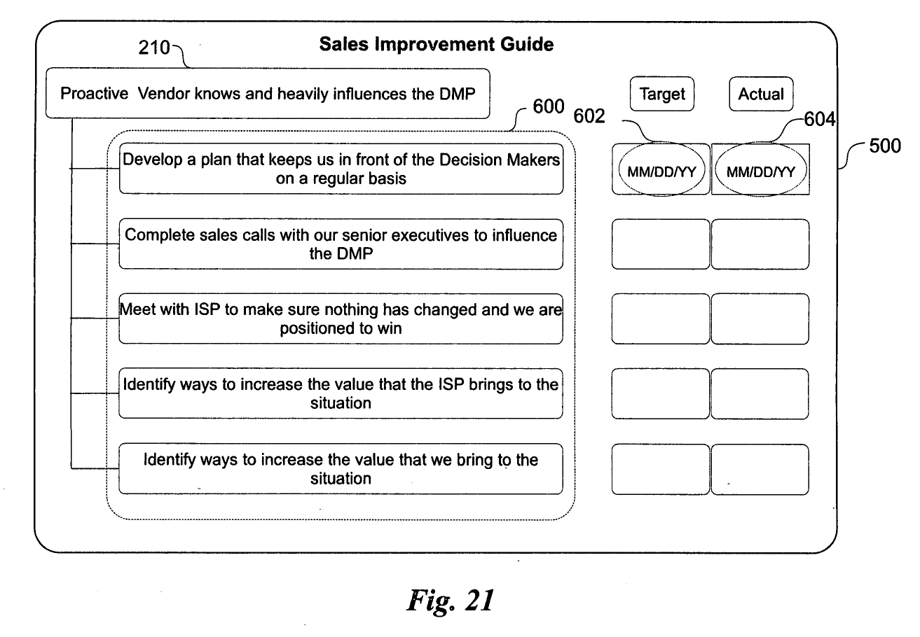

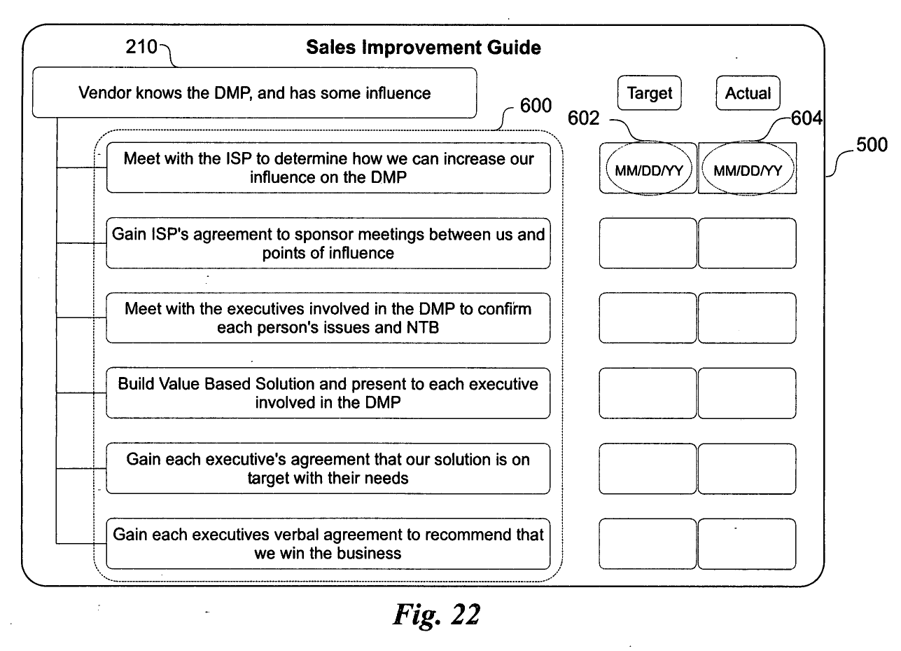

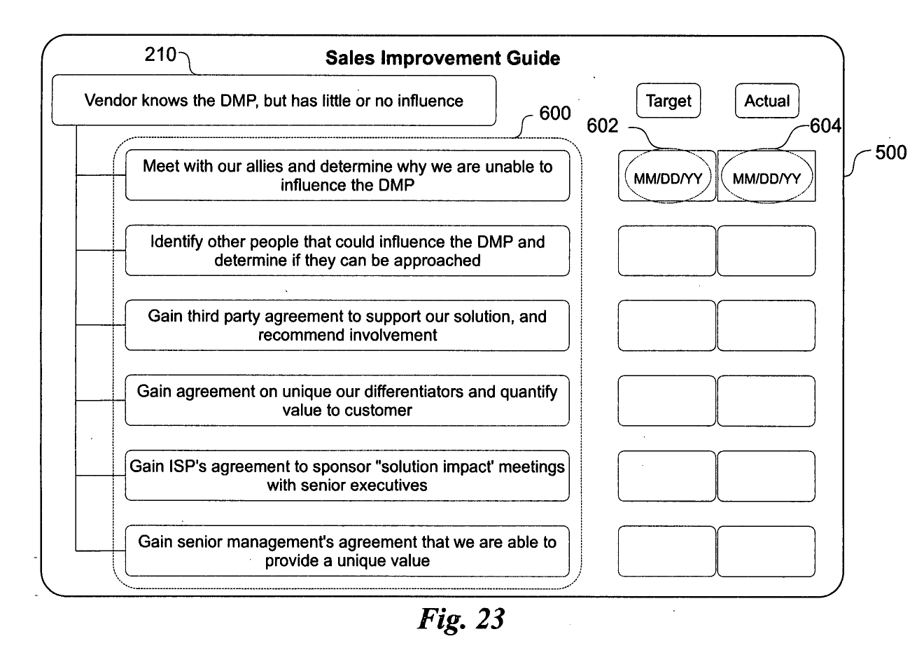

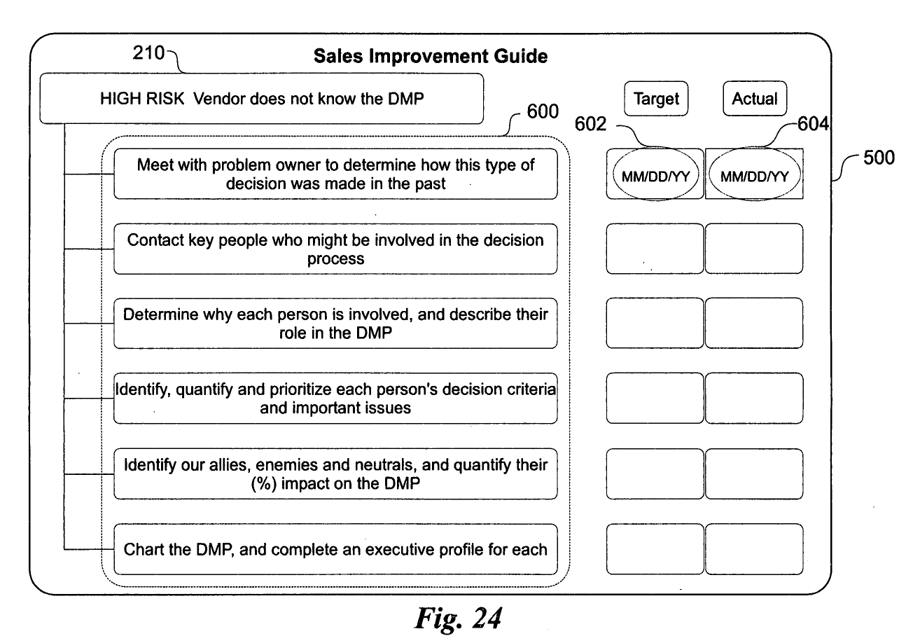

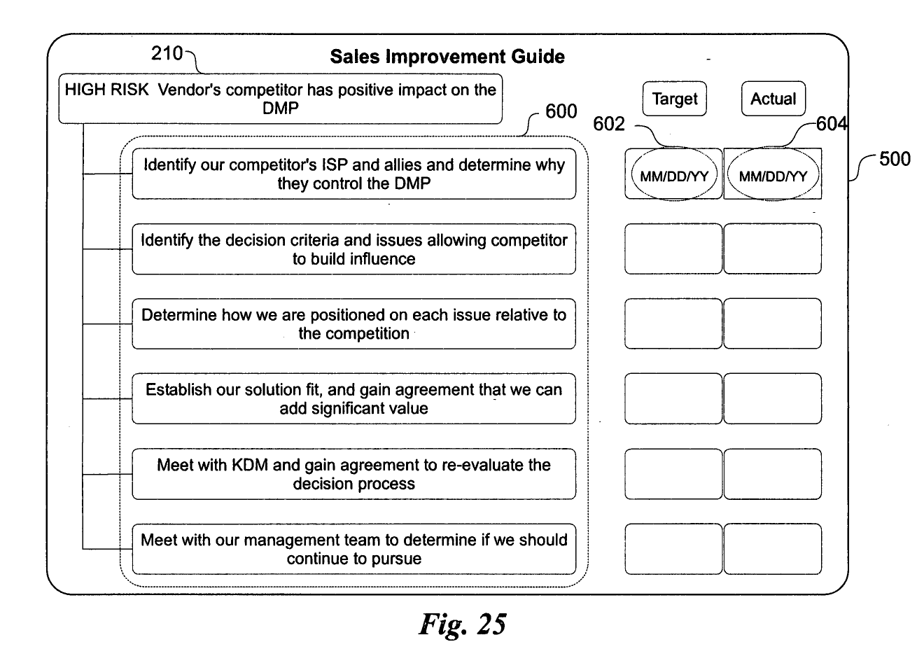

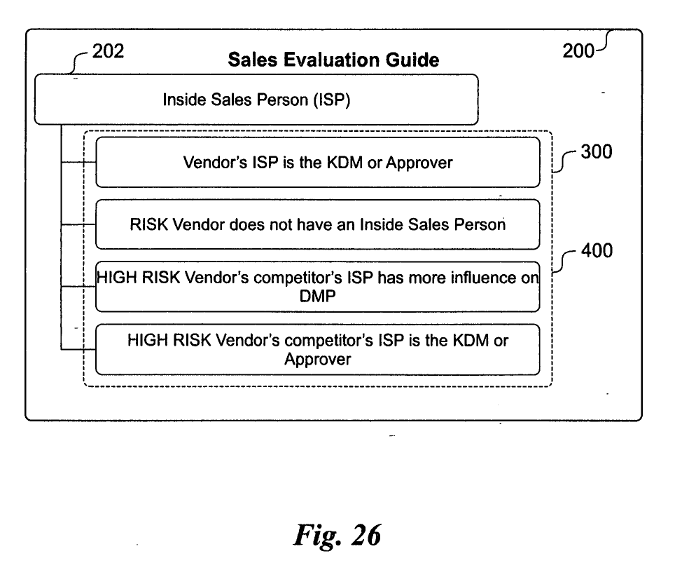

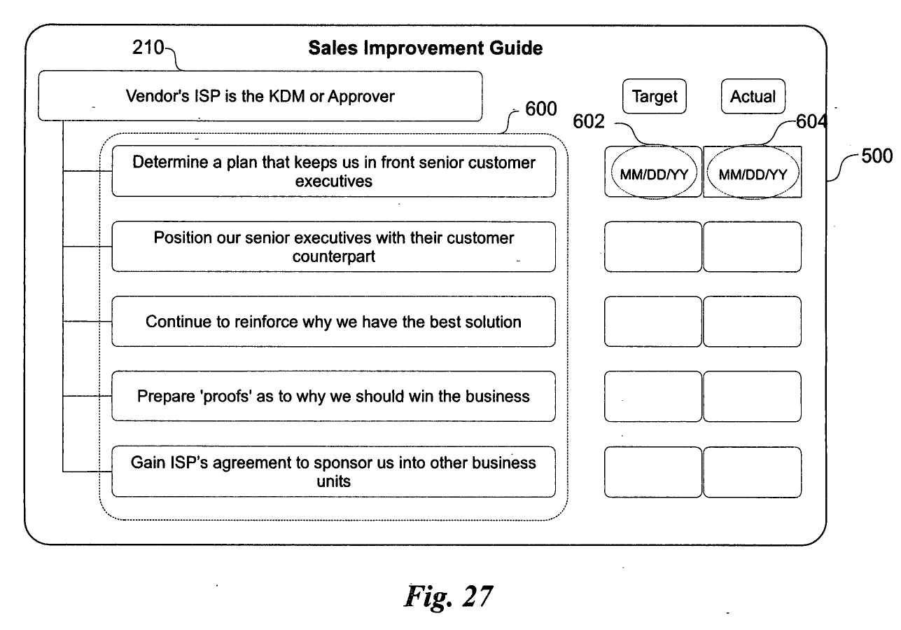

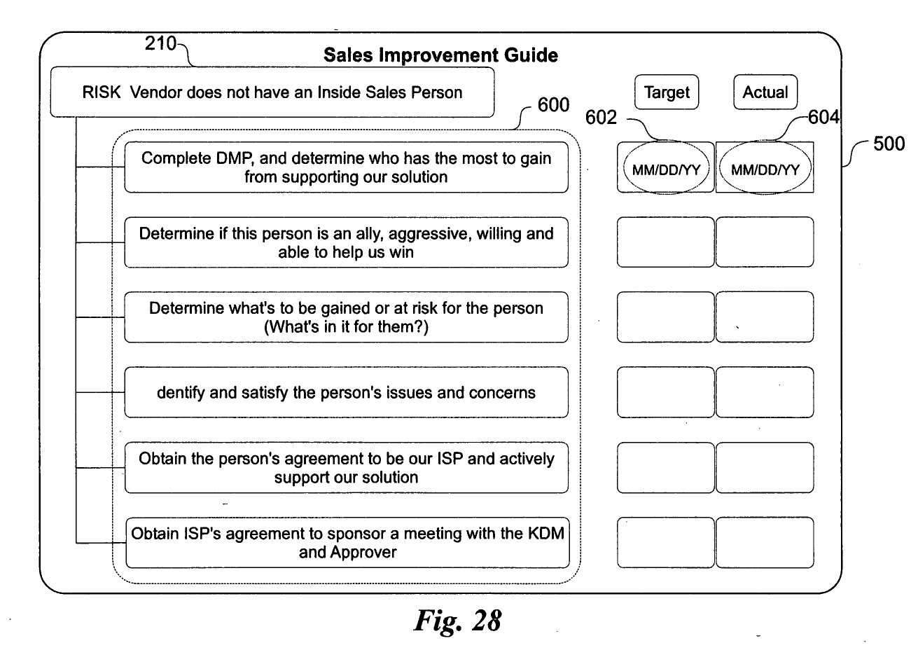

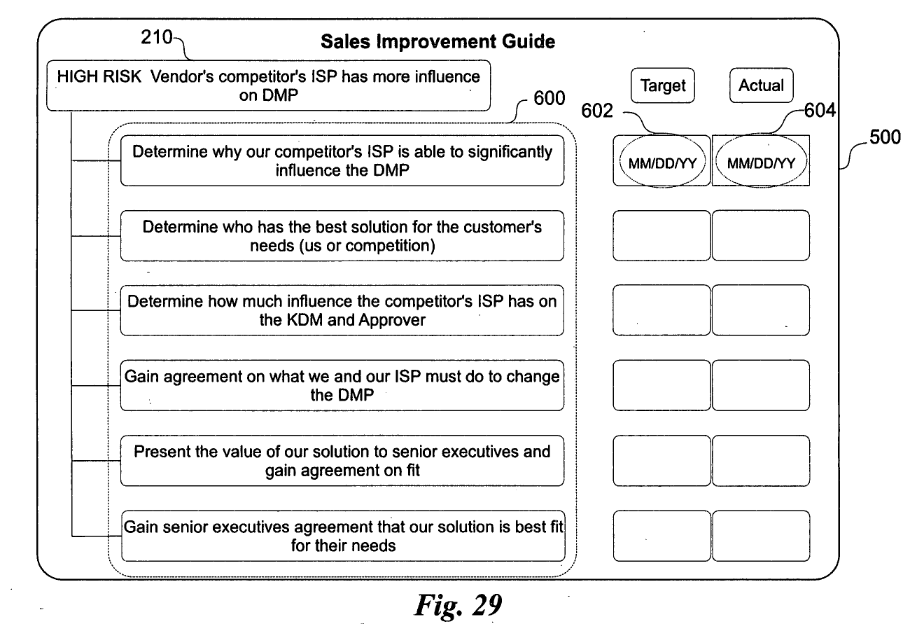

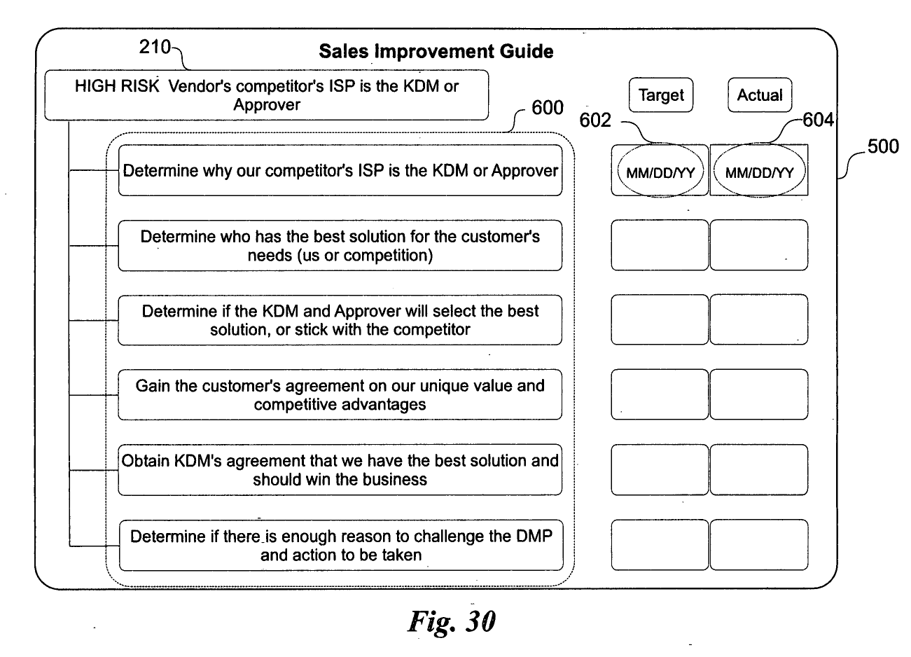

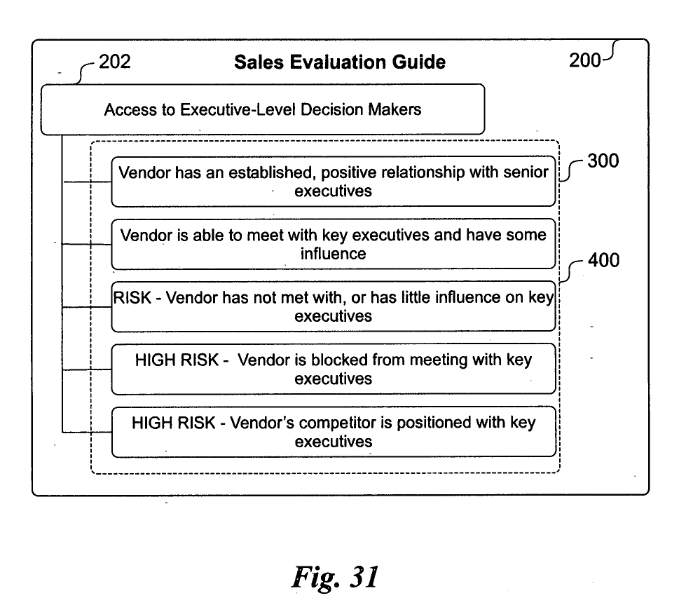

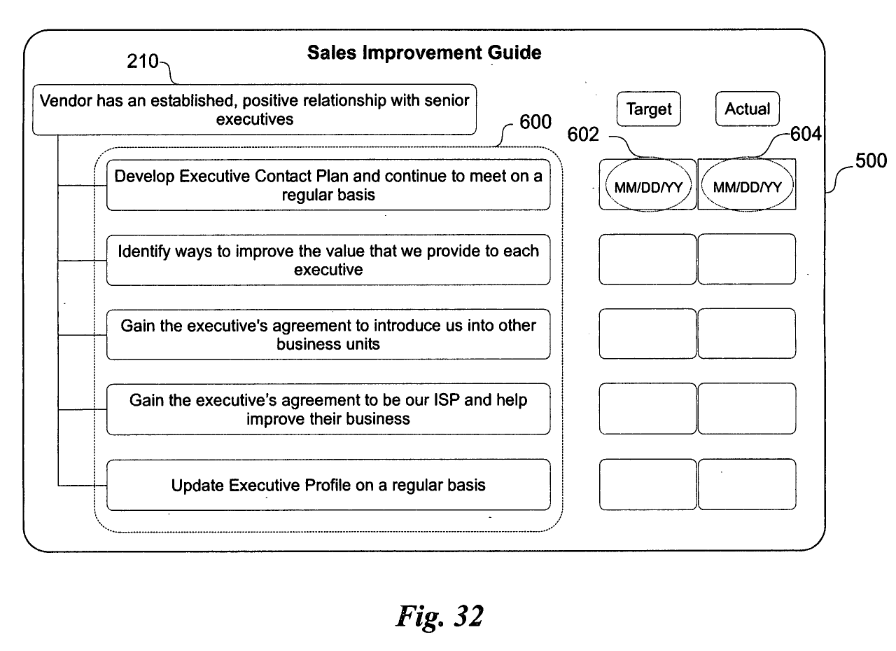

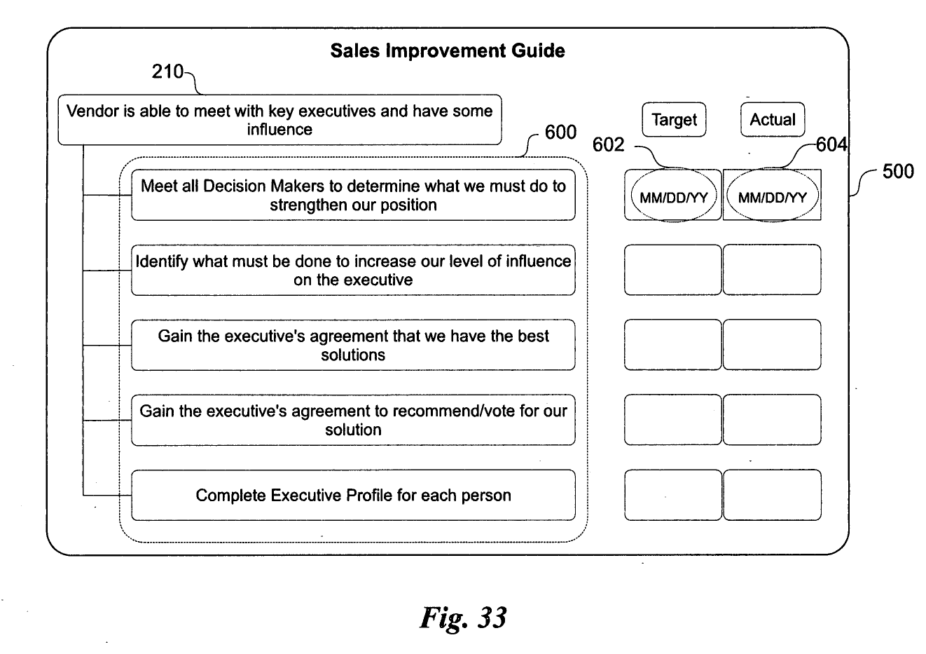

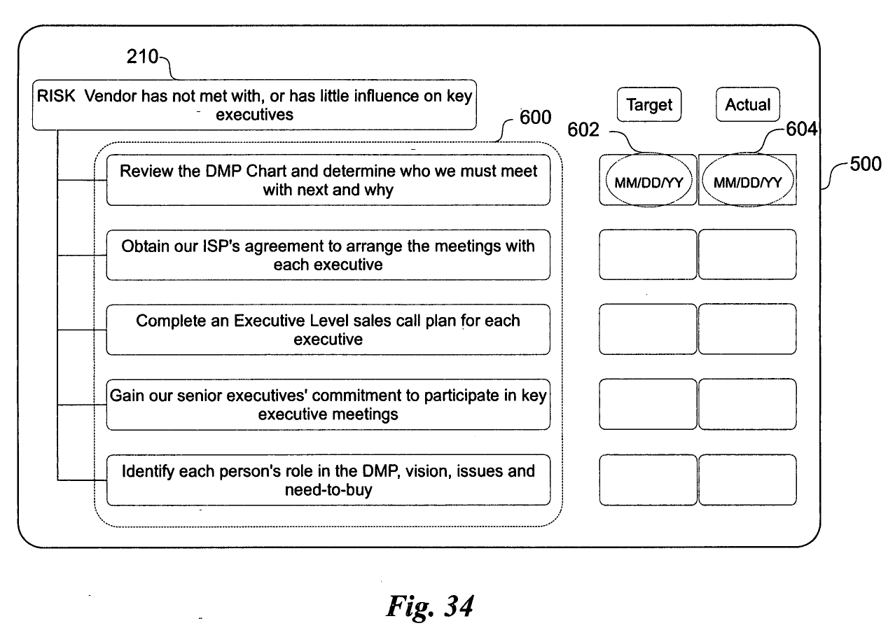

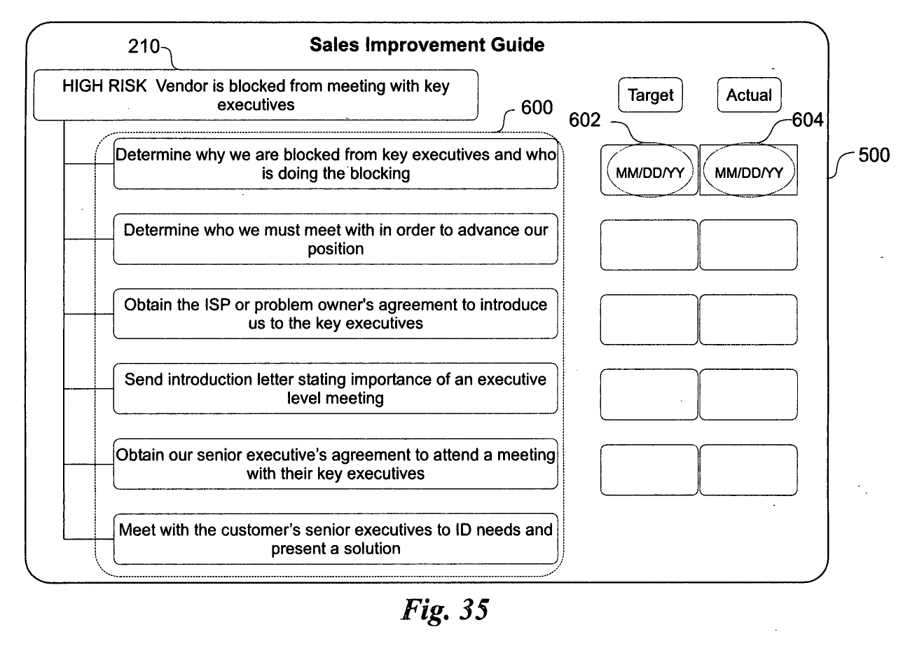

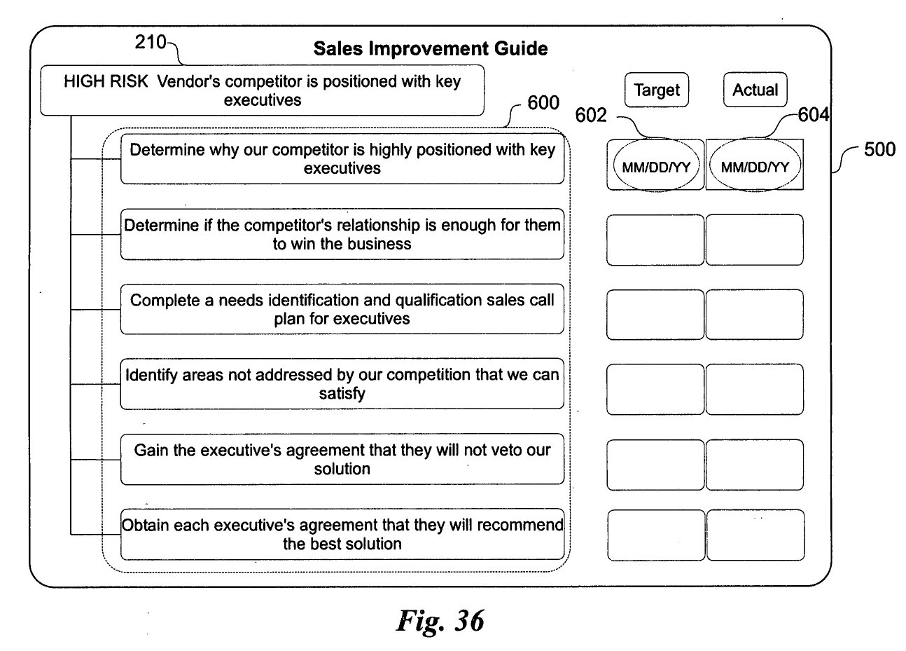

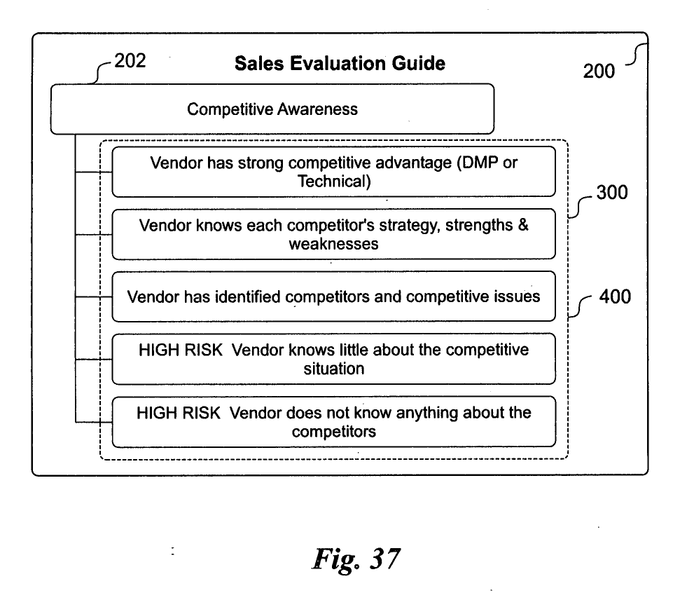

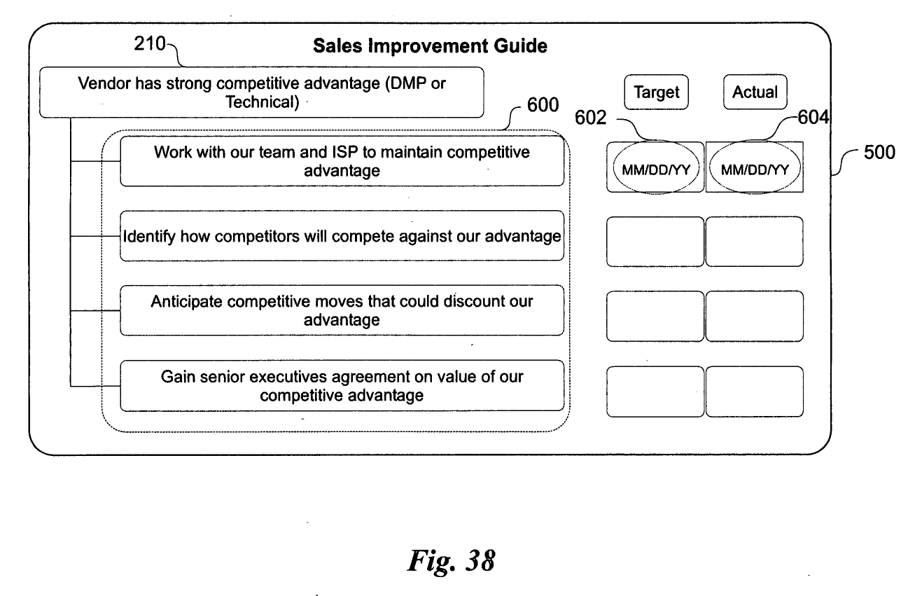

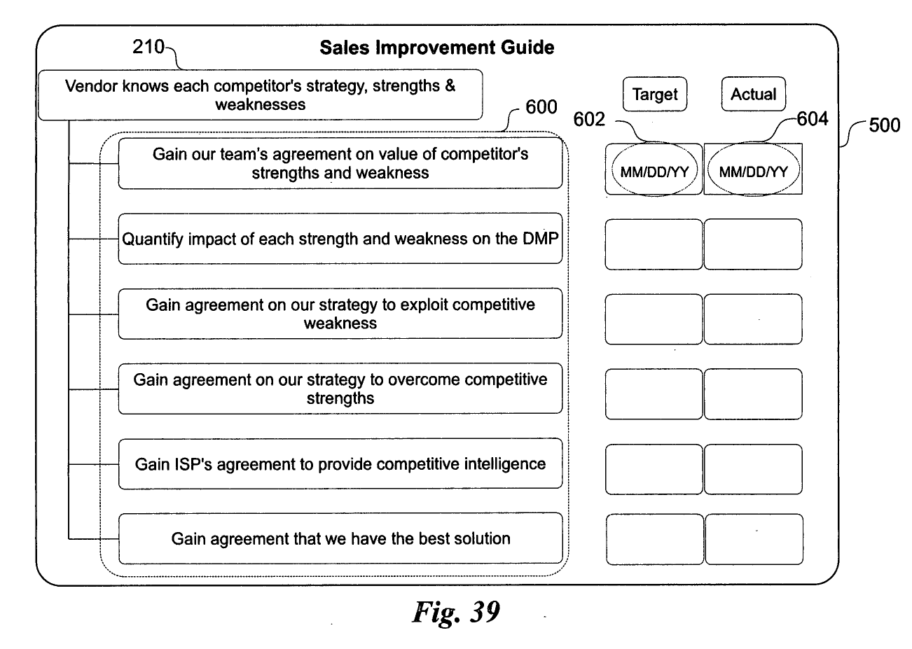

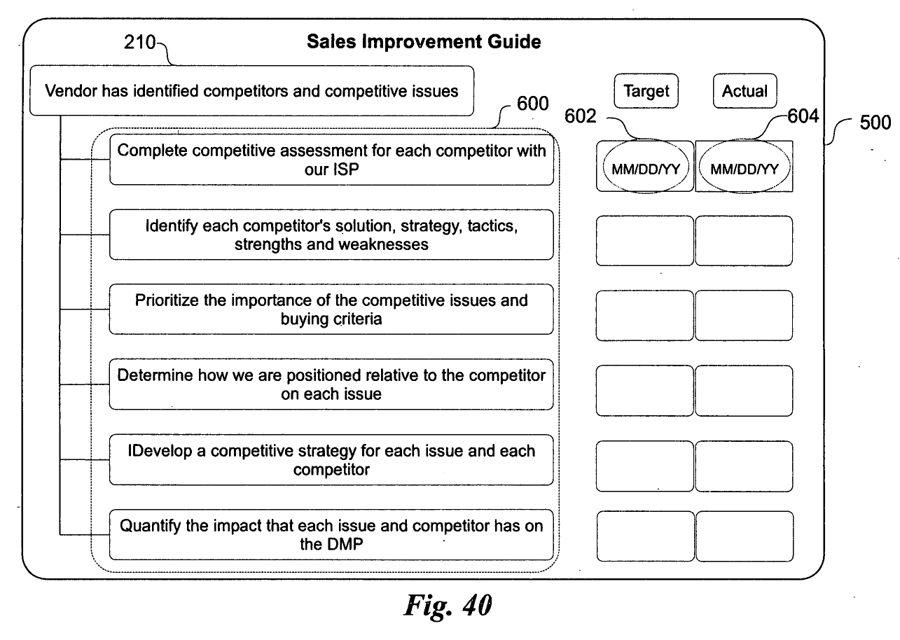

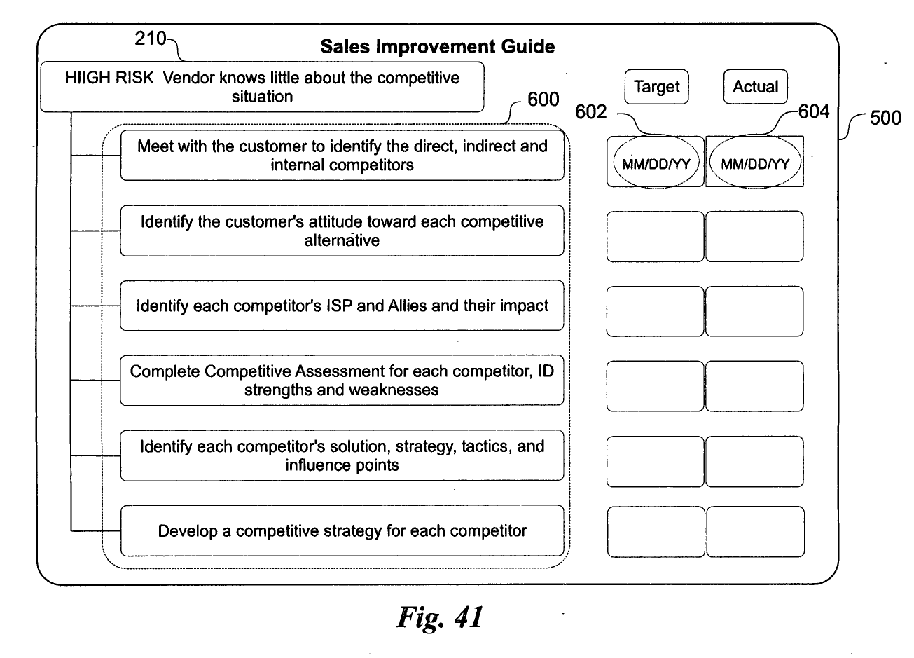

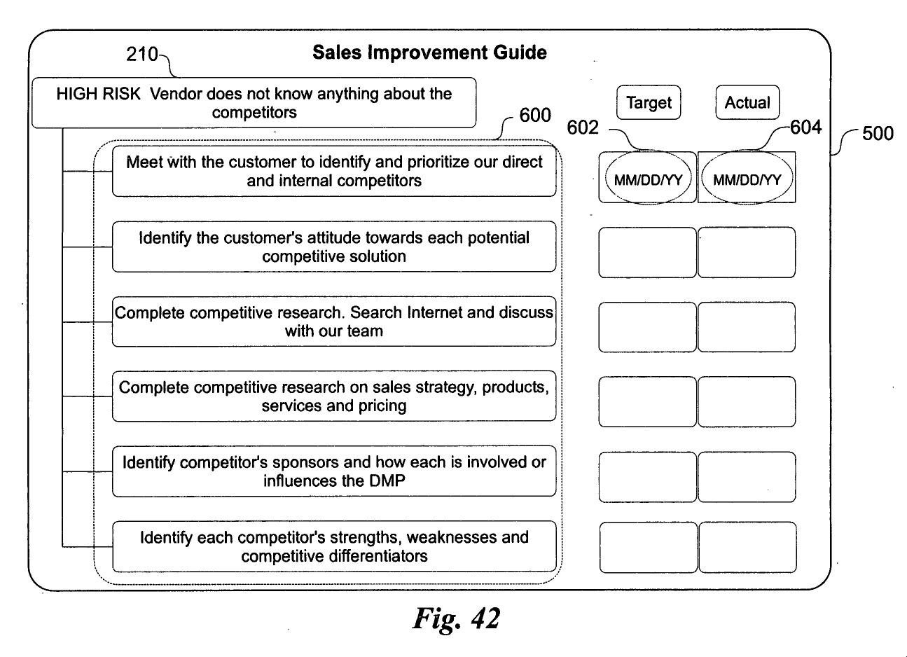

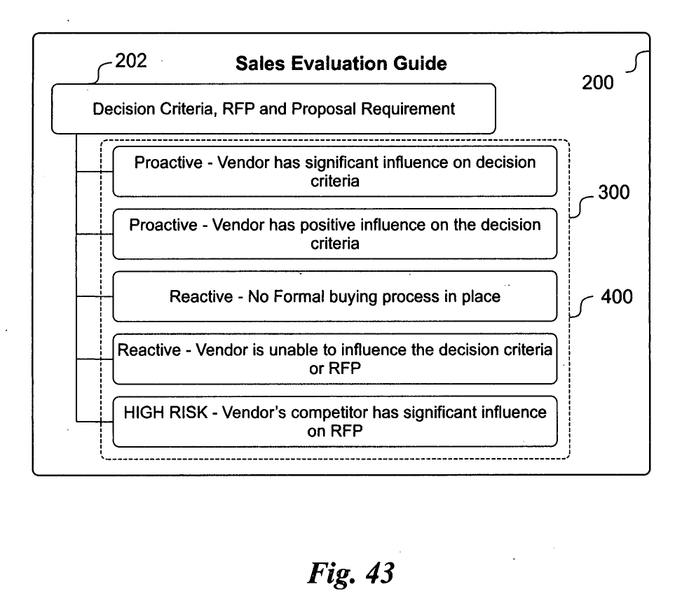

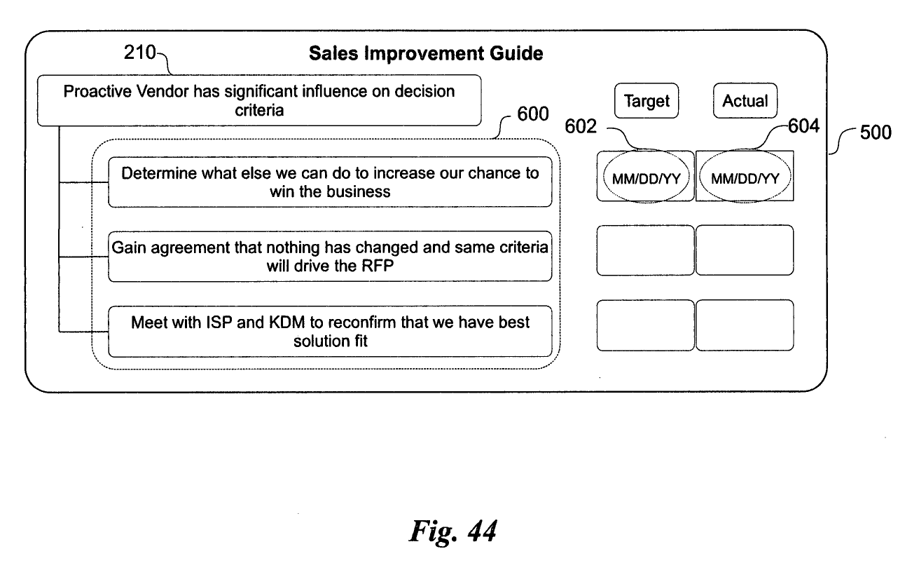

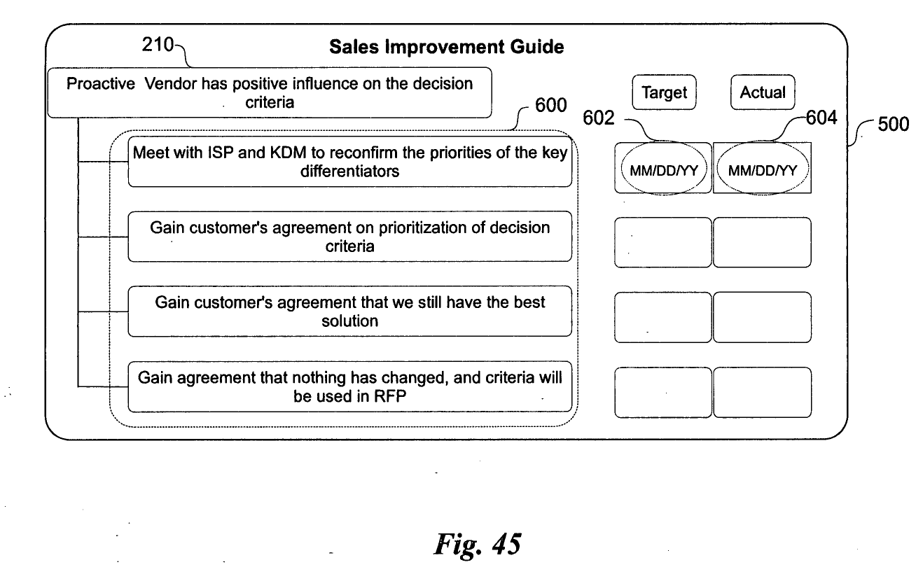

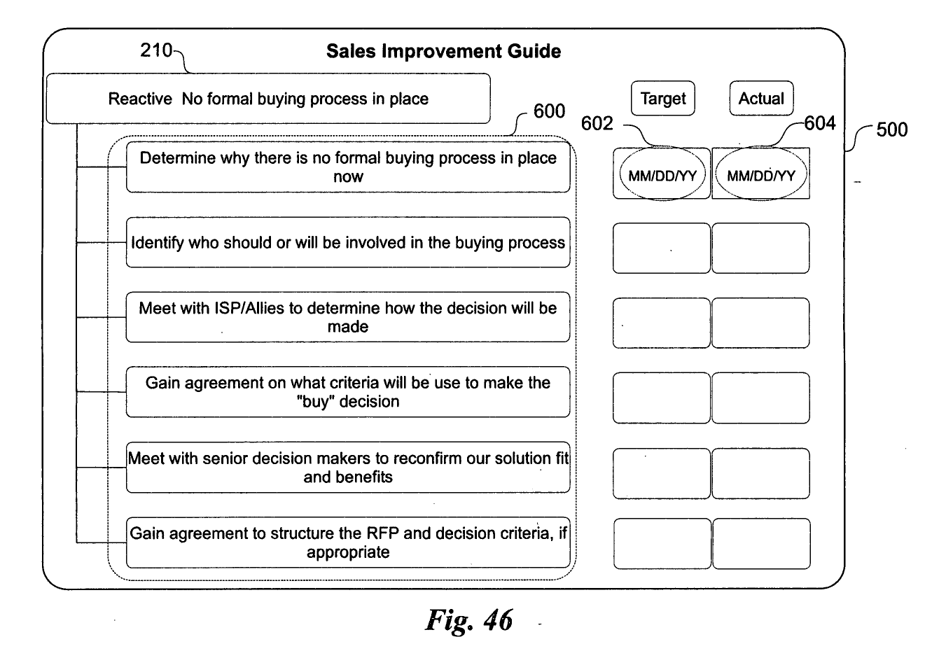

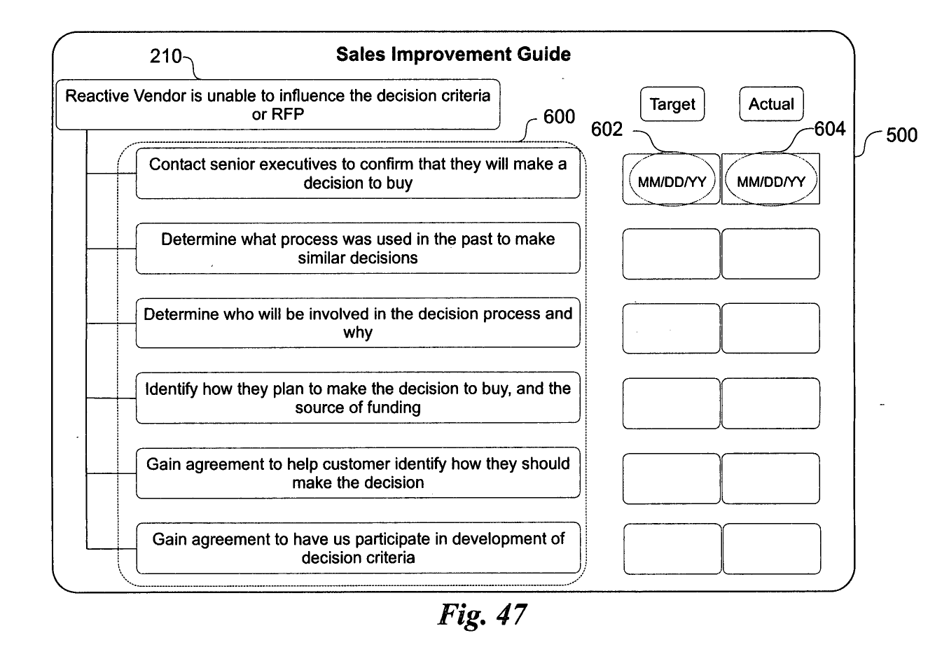

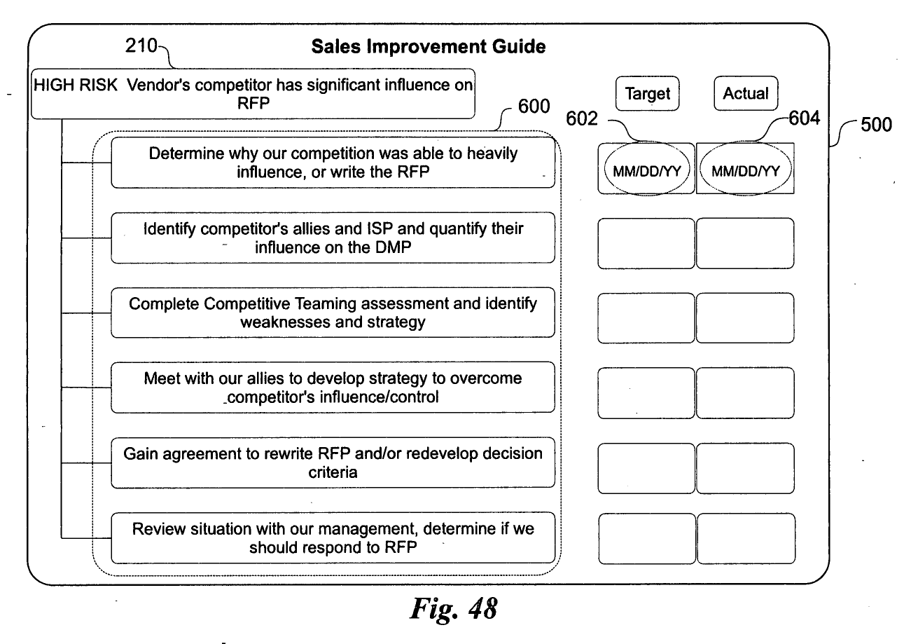

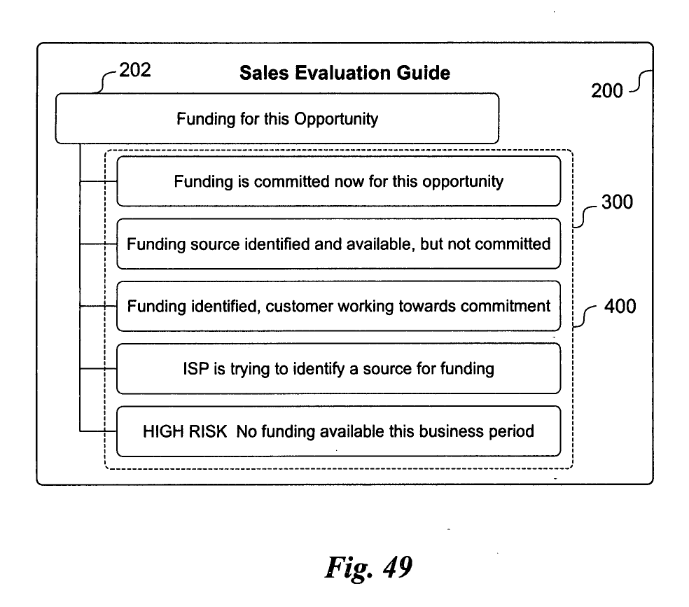

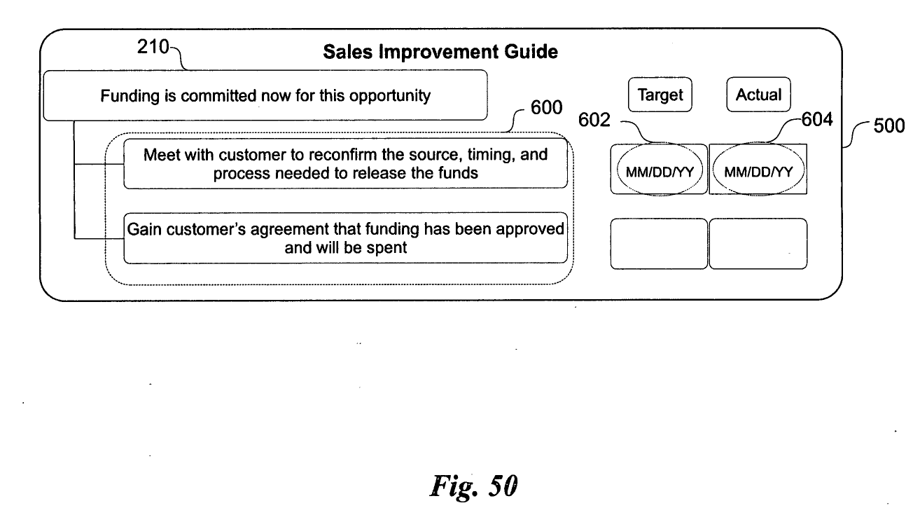

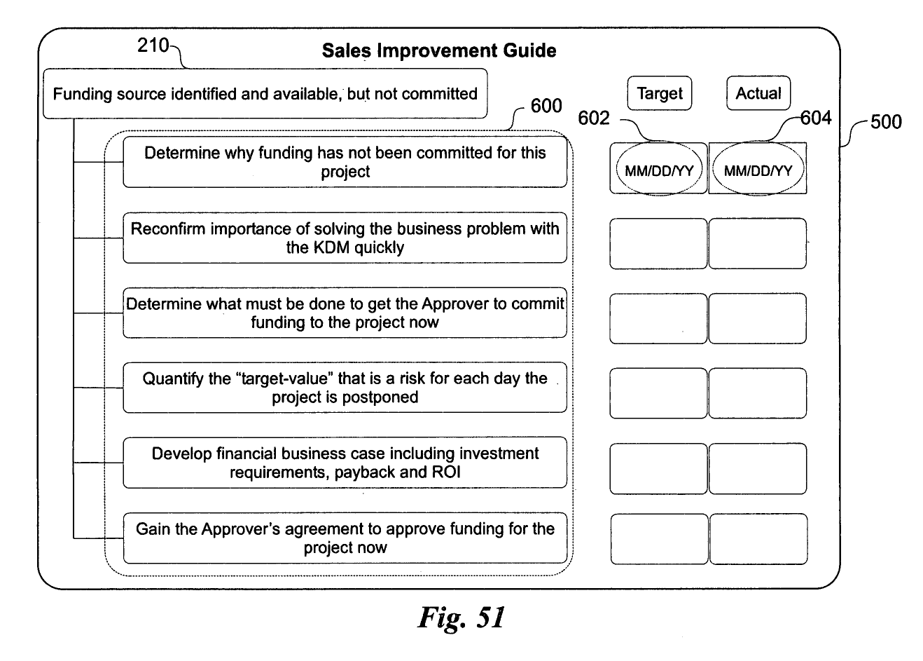

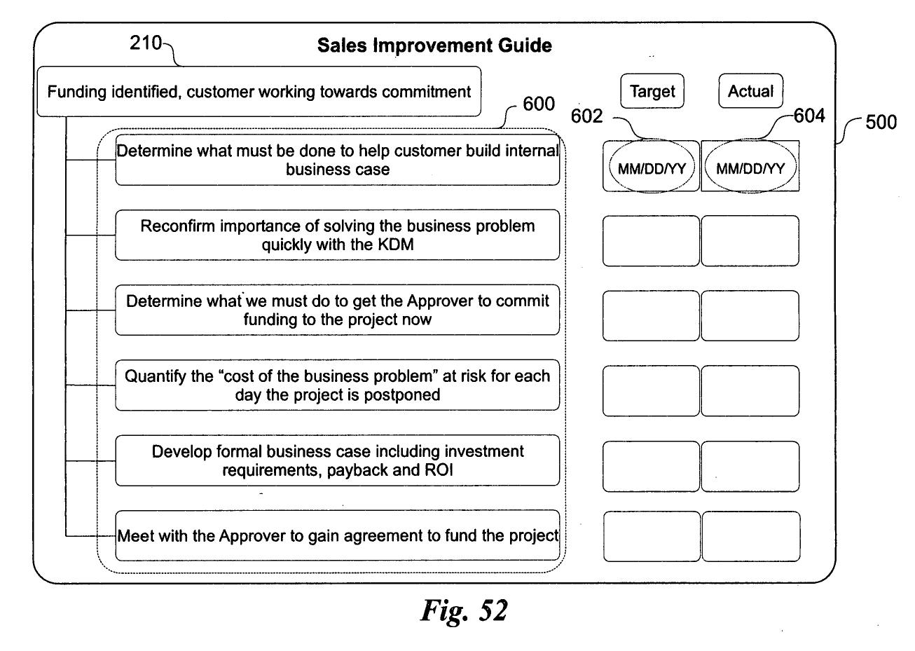

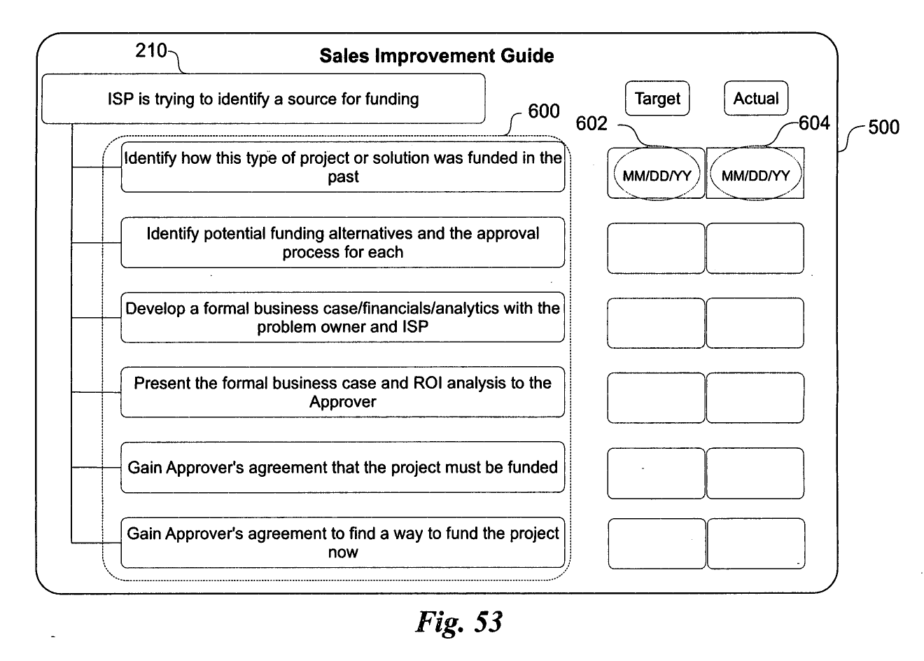

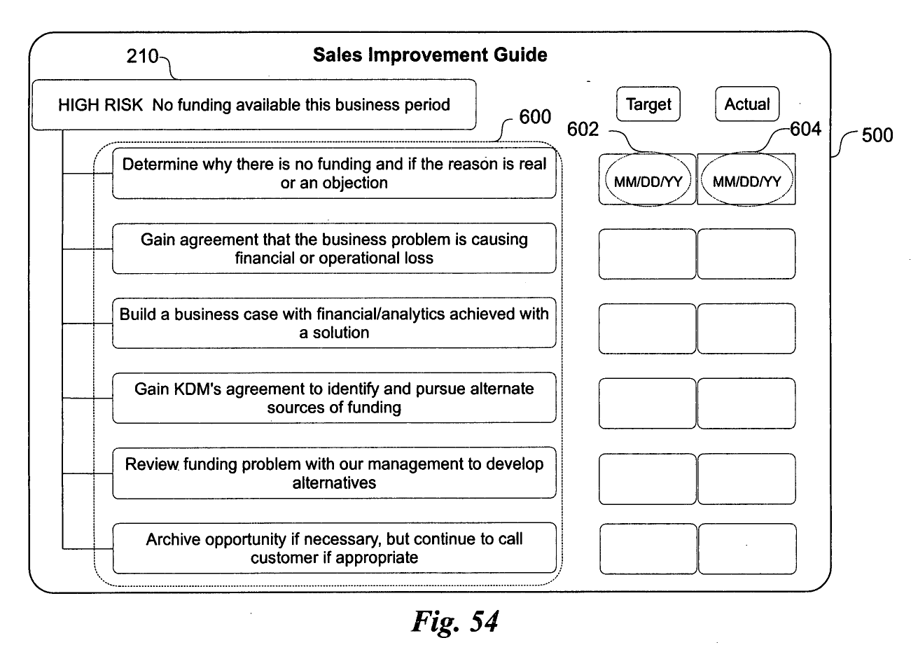

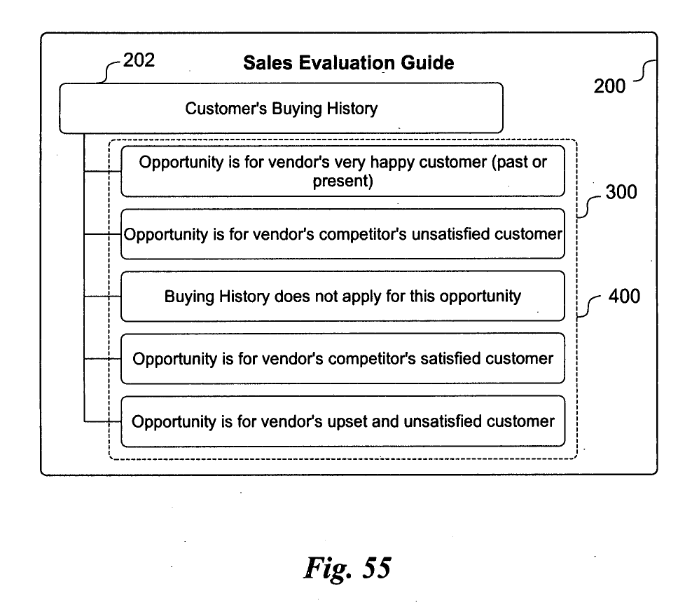

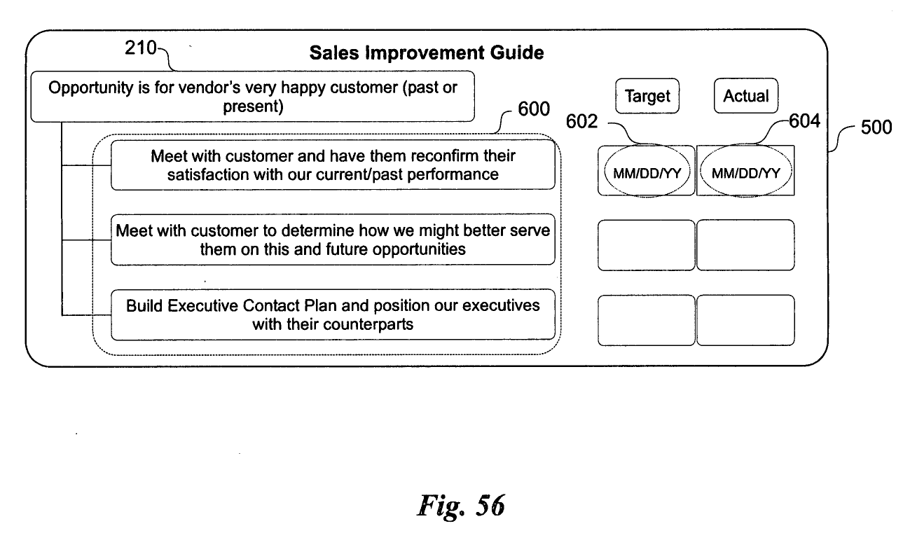

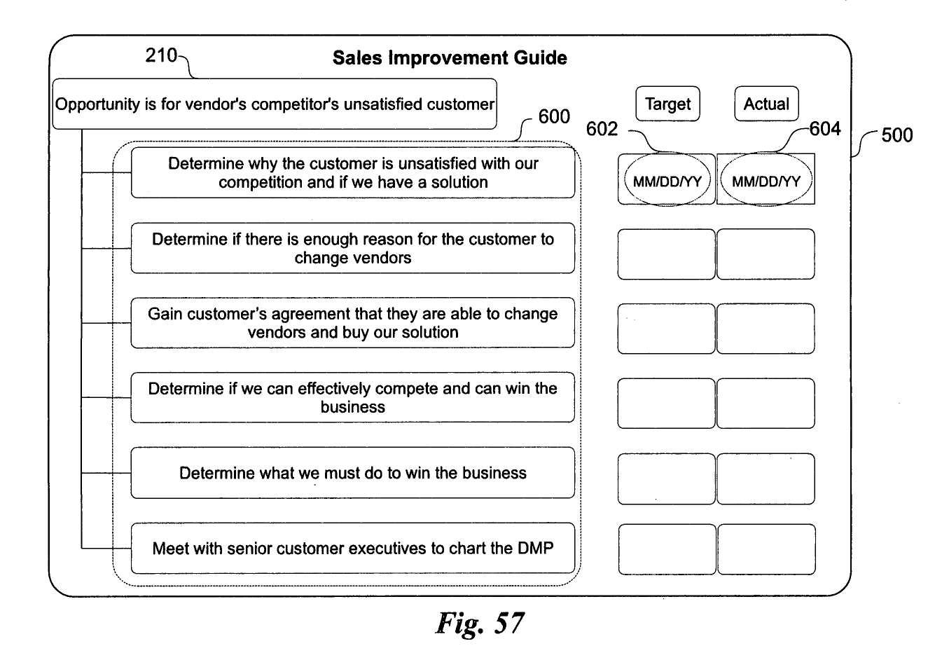

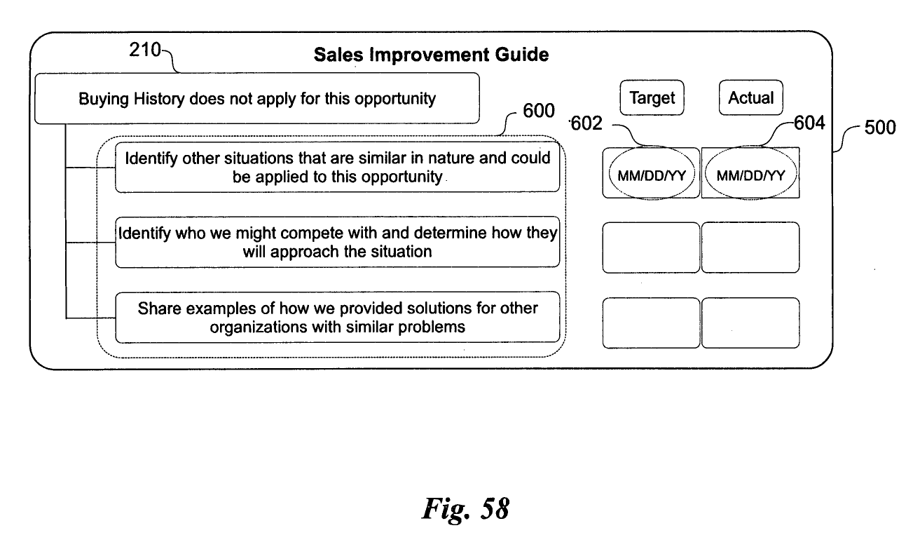

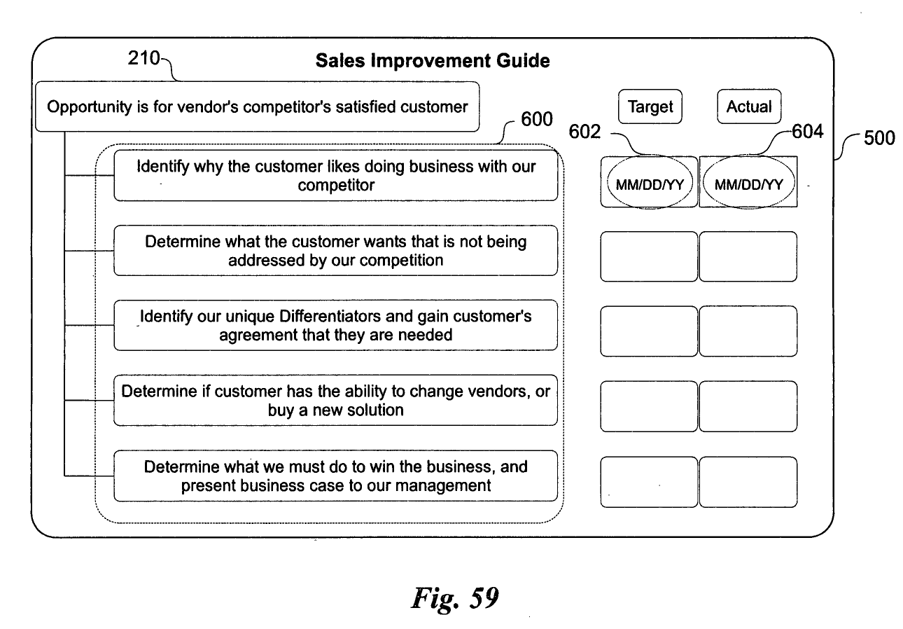

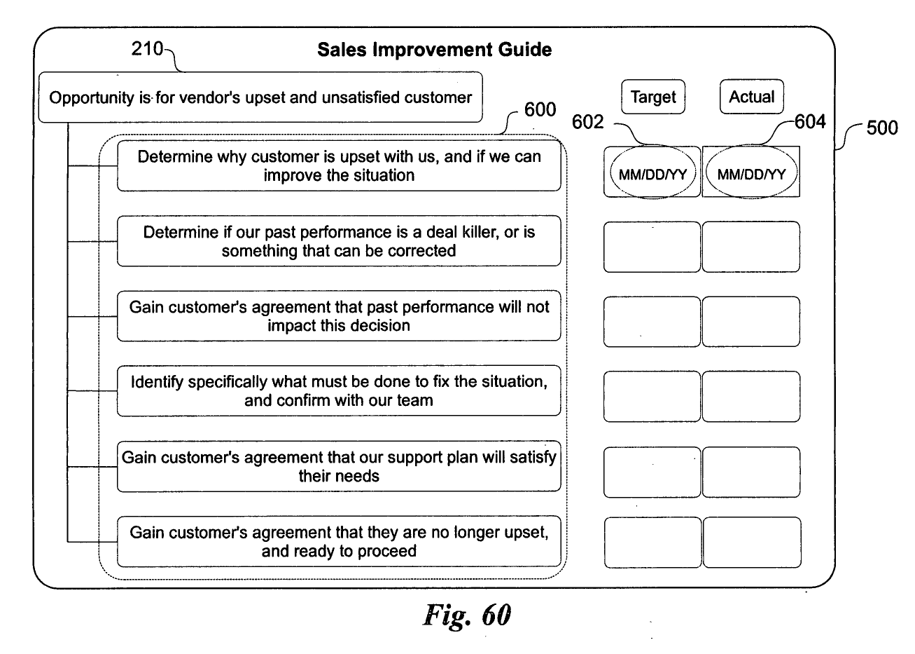

By way of example and not limitation, in other-embodiments, as seen in FIG. 11 through 60, there are other initial stage improvement objectives (600) that may be related to other initial stage responses (210). For instance, as seen in FIG. 11, the predetermined sales evaluation criterion (202) of “Customer's Need-to-Buy (The Business Problem)” may have the primary initial stage ranking (300) and the secondary initial stage ranking (400), as shown. The initial stage response (210) may be selected and the initial stage objectives (600) related to each initial stage response (210) are shown in FIG. 11. Furthermore, examples of the initial stage improvement objectives (600) related to each initial stage response (210) are seen in FIGS. 4, 5, 12, 13, and 14. In other words, each of the primary initial stage ranking (300) and secondary initial stage ranking (400), seen in FIG. 11, may generate initial stage improvement objectives (600) which are seen in FIGS. 4, 5, 12, 13, and 14, for the initial stage response (210). Each figure illustrates one primary or secondary initial stage ranking (300, 400) from FIG. 11 together with initial stage improvement objectives (600) that may be associated with the initial stage response (210). Similarly, FIG. 15 illustrates the predetermined sales evaluation criterion (202) with related primary and secondary initial stage rankings (300, 400). The objectives associated with each of the primary and secondary rankings from FIG. 15 are seen in FIGS. 16 thru 19. Other predetermined sales evaluation criterion (202), the primary and secondary rankings, and related objectives are seen in FIGS. 20 thru 25, FIGS. 26 thru 30, FIGS. 31 thru 36, FIGS. 37 thru 42, FIGS. 43 thru 48, FIGS. 49 thru 54, and FIGS. 55 thru 60.

In one embodiment, the initial stage improvement objectives (600) may include the organization's best practices for improving the probability of winning the sale. In another embodiment of the instant invention, as seen in FIGS. 4 and 5, an initial stage objective completion target date (602) may be determined by the organization. In a related embodiment of the instant invention, an initial stage objective actual completion date (604) may be entered by the salesperson when the initial stage improvement objective (600) is completed. As with the initial stage required action target completion date (116) and the initial stage required action actual completion date (118), the initial stage objective completion target date (602) and the initial stage objective actual completion target date (604) may be used by the organization to track the productivity of its salespeople by comparing the two dates. In another embodiment of the instant invention, the method (50) allows the organization to customize the initial stage improvement objectives (600) to particular customers or according to the organization's products or services.

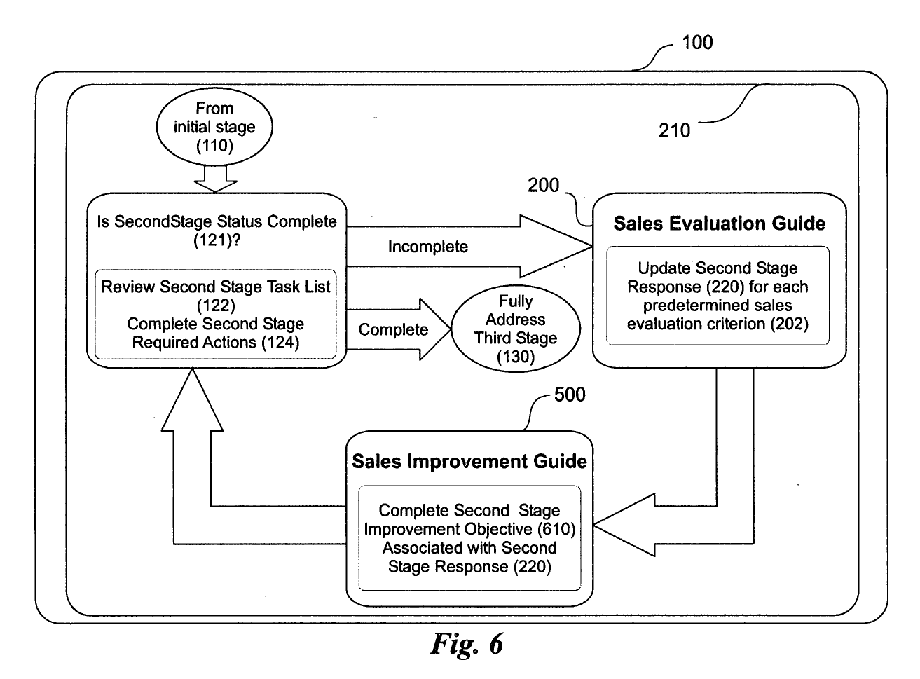

In one embodiment of the instant invention, by completing the initial stage improvement objective (600), as seen in FIG. 1, the salesperson may complete at least one of the incomplete initial stage required actions (114). Following completion of the initial stage improvement objective (600), the initial stage task list (112) may be reviewed. When the initial stage required actions (114) are completed, the initial stage status (111) is complete. A second stage (120) of the progressive sales guide (100) may be fully addressed, as seen in relation between FIGS. 1 and 6.

As seen in FIG. 6, the salesperson fully addresses the second stage (120) after determining that the initial stage status (111) is complete. Like the initial stage (110), the second stage (120) may have a second stage status (121) and a second stage task list (122). The second stage task list (122) in turn has at least one second stage required action (124). As one skilled in the art will observe and appreciate, the salesperson may have completed one or more of the second stage required actions (124), or partially addressed the second stage task list (122), during the initial stage (110). In other words, the method (50) may not require completion of the preceding stages before subsequent stage required actions are completed. Thus, at any point within the progressive sales guide (100) multiple stages may be under various states of completion. However, the earliest stage that is incomplete determines the salesperson's progress within the progressive sales guide (100). The salesperson may not fully address the subsequent stage required actions until the preceding stages are complete. By way of example and not limitation, the prospective customer (20) may require submission of a “Formal Proposal, Contract, and Implementation Plan” for review by the prospective customer's (20) legal department, a later stage required action, prior to having any other discussion with the salesperson. In this situation then, the salesperson would submit the requested information to the prospective customer (20) and then enter a completion date for that stage required action, even though the initial stage task list (112) is incomplete. The salesperson would still be considered in the initial stage (110). By way of example, and not limitation, other second stage required actions (124) are seen in FIG. 6. In the embodiment of the instant invention, as seen in FIG. 6, the process is similar to that shown in FIG. 1, though it is not necessary that each stage contain similar guides, as disclosed below.

Referring now to FIG. 6, after determining if the second stage status (121) is incomplete, by verifying if one of the second stage required actions (124) is incomplete, the salesperson proceeds to the sales evaluation guide (200). The salesperson updates the sales evaluation guide (200) by selecting a second stage response (220) to the predetermined sales evaluation criterion (202). The second stage response (220) may be selected from a primary second stage ranking (310) and a secondary second stage ranking (410) associated with one or more predetermined sales criterion (202). As one skilled in the art will observe, and in one embodiment of the instant invention, the predetermined sales criterion (202) may be the same as the predetermined sales criterion (202) provided in the initial stage (110). In this embodiment then, the primary second stage ranking (310) and the secondary second stage ranking (410) may be the same as the primary initial stage ranking (300) and the secondary initial stage ranking (400), as previously described and as seen in FIG. 3. Generally, the choices of primary rankings (300, 310) are the same, as are the choices of secondary rankings (400, 410). In another embodiment of the instant invention, the primary rankings (300, 310) describe an improved sales probability, in other words, the primary rankings (300, 310) describe a more desirable sales position than the secondary rankings (400, 410). Thus, when the salesperson proceeds through the second stage (120) and the second stage response (220) to the predetermined sales criterion (202) is an improvement over the initial stage response (210), the probability of selling improves. In another embodiment of the instant invention, the primary second stage ranking (310) may have a primary second stage ranking score (312) and the secondary second stage ranking (410) may have a secondary second stage ranking score (412) much like the initial stage (110). In addition, the second stage response (220) may have a second stage sales score (222). The second stage sales score (222) may be calculated from one of the primary second stage ranking score (312) and the secondary second stage ranking score (412) depending upon whether the primary second stage ranking (310) or the secondary second stage ranking (410) is selected by the salesperson.

As initially explained, a goal in utilizing the method (50) may be to improve the probability of making the sale to the prospective customer (20). Thus, in one embodiment of the instant present invention, as previously mentioned, a goal is to be able to select more desirable second stage responses (220) during the second stage (120) which represents an improvement in the selling probability. However, selection of more desirable second stage responses (220) is not necessary. As one skilled in the art will observe, selection of less desirable second stage responses (220) during the second stage (120) may be used to indicate or identify problems before the problem becomes fatal to the sale.

In another embodiment of the instant invention similar to an embodiment of the initial stage (110), the second stage sales score (222) may be an objective evaluation of the probability of the salesperson “winning” the prospective customer's business, that is, the probability that the prospective customer (20) becomes the customer. In another embodiment of the instant invention, the second stage sales score (222) may decrease from the initial stage sales score (212) even though the second stage response (220) selected for each of the predetermined sales evaluation criterion (202) are the same as the initial stage response (210). In this case then, the second stage sales score (222) decreases due to a failure to improve the second stage response (220). Thus, if the second stage response (220) is not better than the initial stage response (210) then the second stage sales score (222) may be lower than the initial stage sales score (212) to reflect the fact that the predetermined sales evaluation criterion (202) is in no better position now than it previously was, and thus the successful completion of a sale is less likely. This aids the organization in determining if pursuing the prospective customer's business is a waste of sales resources and that those resources may be better utilized with another prospective customer. In one particular embodiment of the instant invention, where the second stage responses (220) are identical to the initial stage responses (210), the second stage sales score (222) is at least approximately 10% less than the initial sales score (212).

By way of example and with reference to FIG. 3, during the initial stage (110), when the salesperson selects the initial stage response (210) of “HIGH RISK—No Need-to-Buy, (little interest), no commitment to proceed” in response to the predetermined sales evaluation criterion (202), the initial sales score (212) may be “0,” thus representing that the sale is not likely. When the salesperson proceeds through the second stage (120) and again selects “HIGH RISK—No Need-to-Buy, (little interest), no commitment to proceed” as the second stage response (220), indicating that the salesperson was unable to improve the ranking, the second stage sales score (222) may fall to “−15,” representing a drop in the probability of selling between the initial and second stages (110, 120). At this point the organization may decide to have the salesperson move on to other prospective customers (20).

Referring now to FIG. 6, following updating the second stage response (220), the salesperson completes the sales improvement guide (500). Similar to the sales improvement guide (500) in the initial stage (110), the sales improvement guide (500) in the second stage (120) has at least one second stage improvement objective (610). The second stage improvement objective (610) may be related to the second stage response (220). By way of example and not limitation, the second stage improvement objectives (610) may be similar to the initial stage improvement objectives (600), as previously discussed.

As seen in FIG. 6, once one or more of the second stage improvement objectives (610) is completed, the salesperson may determine the second stage status (121). When the second stage required actions (124) are complete, the second stage status (121) is complete and the salesperson may fully address a third stage (130). As one skilled in the art will recognize and appreciate, many more stages may succeed the initial, second, and third stages (110, 120, 130) based on the same principles described in the initial and second stages (110, 120).

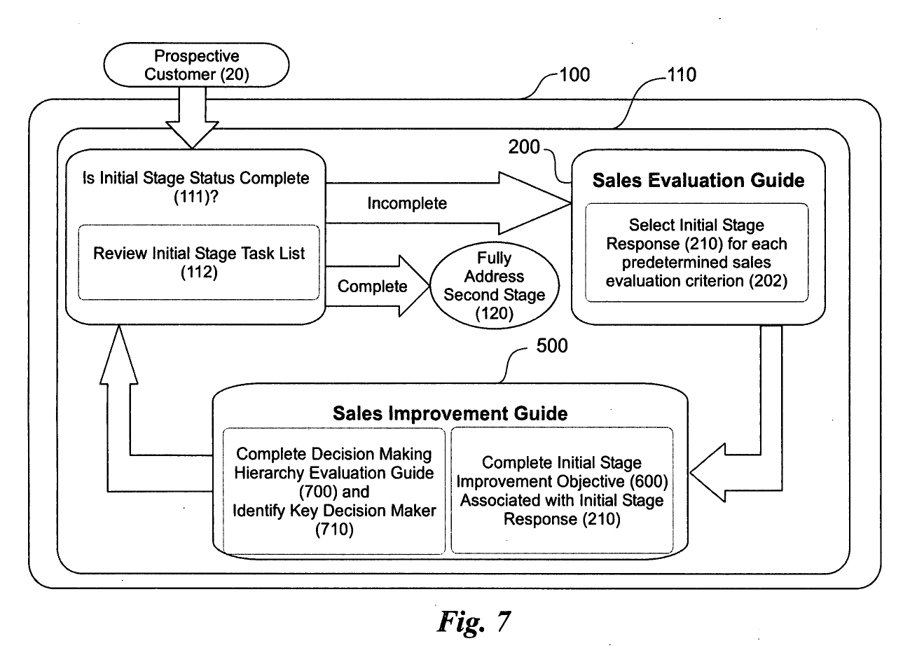

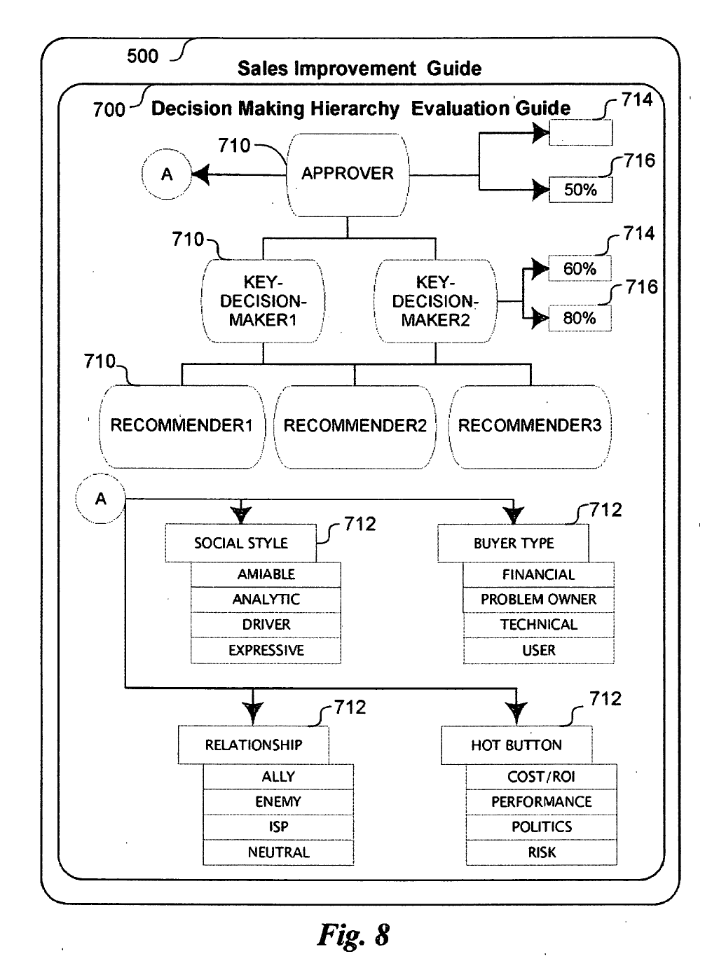

In another embodiment of the present invention, as seen in FIGS. 7 and 8, the step of completing the sales improvement guide (500) may also include completing a decision making hierarchy evaluation guide (700). The decision making hierarchy evaluation guide (700) may help the salesperson organize and identify at least one decision maker (710) at the prospective customer (20). The decision makers (710) are those people that may be responsible for making a decision or recommendation to purchase the product. In one embodiment of the present invention, as seen in FIG. 8, a relationship between a plurality of the decision makers (710) may be established and the decision makers (710) may be, by way of example and not limitation, referred to as “APPROVER,” “KEY-DECISION-MAKER,” “RECOMMENDER,” or some other descriptive title. In another embodiment of the invention having the decision maker (710), additional characteristics of the decision maker (710) may be quantified by providing a selection of predetermined characteristics, as seen in FIG. 8. The characteristics for each decision maker (710) may include, for example, a predetermined character trait (712) which may include the “SOCIAL STYLE” of the decision maker (710). Furthermore, the selections attributed to the “SOCIAL STYLE” of the decision maker (710) may be, by way of example and not limitation, “AMIABLE,” “ANALYTIC,” “DRIVER,” and “EXPRESSIVE,” as seen in FIG. 8. Other attempts to quantify the predetermined character traits (712) of the decision maker (710) may be made to provide the salesperson with the edge in the sales process. By having the salesperson identify the predetermined character traits (712) explicitly, it may be possible to utilize this information when additional contacts are made with the prospective customer (20). By way of example only, when the salesperson contacts the prospective customer (20) to speak to the decision maker (710), the salesperson, having identified the predetermined character traits (712), such as the “HOT BUTTON” of that decision maker (710), may discuss the product in a manner that focuses the information to the “HOT BUTTON” of that the decision maker (710). Thus, the salesperson may improve the sale probability by tailoring discussion with the decision maker (710) according to the decision maker's (710) predetermined character traits (712).

Another embodiment of the instant invention, as seen in FIG. 8, may include a decision maker influencer value (714) where the salesperson may select a percentage of influence that the decision maker (710) has on one or more other decision makers (710). In a related embodiment, a decision maker influenced value (716) may allow the salesperson to gauge how much autonomy the decision maker (710) uses when making the decision regarding purchasing the product (20). By way of example and not limitation, as seen in FIG. 8, the decision maker (710), or “APPROVER,” may have the decision maker influenced value (716) of 50%, such that 50% of the APPROVER's decision is influenced by others. The “KEY-DECISION-MAKER2” decision maker (710) has a decision maker influenced value (716) of 80%, so that 80% of KEY-DECISION-MAKER2's decision may be influenced by “RECOMMENDER1,” “RECOMMENDER2,” and “RECOMMENDER3.” KEY-DECISION-MAKER2 also has a decision maker influencer value (714) of 60% meaning that KEY-DECISION-MAKER2 may be able to influence 60% of APPROVER's 50% decision maker influenced value (716).

By way of example and not limitation, with reference to FIG. 8, the salesperson would naturally want to sell the product to the “APPROVER.” However, if the salesperson has limited access to the “APPROVER,” then identifying other decision makers (710) who have influence on the “APPROVER” may help the salesperson improve the probability of selling the product, even though access to the “APPROVER” is limited. For example, by gaining the support of “KEY-DECISION-MAKER2” such that the salesperson develops predetermined character trait (712) “RELATIONSHIP” of “ALLY” with “KEY-DECISION-MAKER2,” The salesperson may sell indirectly to “APPROVER” because “KEY-DECISION-MAKER2” influences 60% of the 50% decision maker influenced value (716) of “APPROVER.” Furthermore, as one skilled in the art will observe, each decision maker (710) identified may have the predetermined character trait (712), the decision maker influencer value (714), and the decision maker influenced value (716).

As with the predetermined character traits (712), the decision maker influencer value (714) and the decision maker influenced value (716) may provide the salesperson with additional insight into the prospective customer (20) and may increase the salesperson's probability of winning the sale. The interrelationship of the sales evaluation guide (200) and the sales improvement guide (500) may substantially require the salesperson to continually evaluate the decision makers (710) of the decision making hierarchy evaluation guide (700) in conjunction with the initial stage improvement objective (600). In one embodiment of the instant invention, the stage required actions (114, 124) may relate to one or more decision makers (710), the predetermined character traits (712), the decision maker influencer value (714), and the decision maker influenced value (716). In addition, the predetermined sales criterion (202) may prompt the salesperson to focus on identifying and quantifying the predetermined character traits (712) of one or more decision maker (710). Moreover, the improvement objectives (600, 610) may target the salespersons activities towards identifying the decision maker (710), the predetermined character traits (712), the decision maker influencer value (714), or the decision maker influenced value (716), or any combination thereof. As one skilled in the art will observe and appreciate, the task lists (112, 122), the sales evaluation guide (200), the sales improvement guide (500), and the decision making hierarchy evaluation guide (700) may be interrelated. Thus, selections made by the salesperson in response to the predetermined sales evaluation criterion (202) may generate improvement objectives (600, 610) directed toward the decision making hierarchy evaluation guide (700) and the task lists (112, 122). When the salesperson completes the improvement objectives, the probability of winning the sale during subsequent stages may improve.

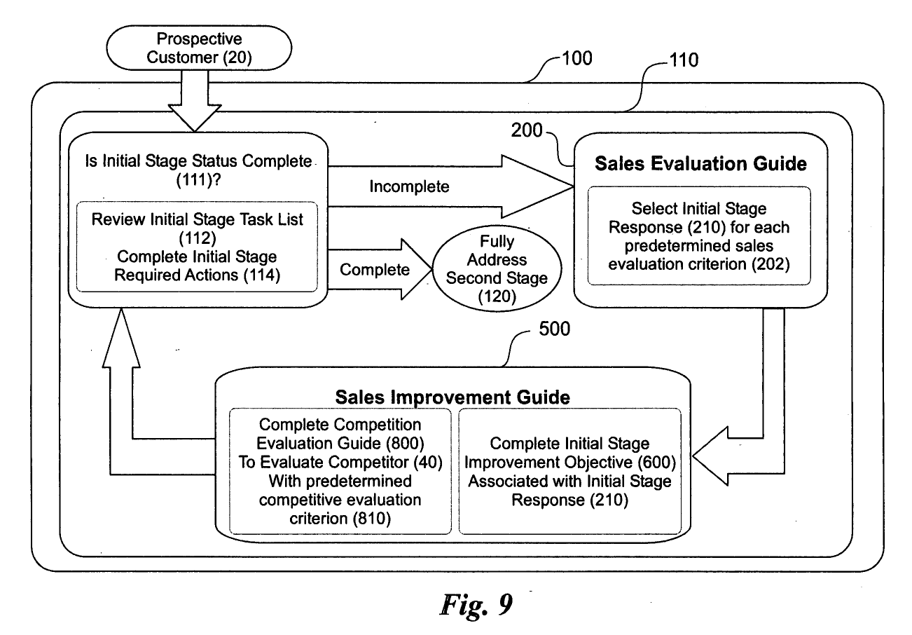

In another embodiment of the instant invention, as seen in FIG. 9, the sales improvement guide (500) may further include a competition evaluation guide (800). By way of example and not limitation, the competition evaluation guide (800) may be used for evaluating the organization's competitive advantages or key discriminators, for evaluating a competitor's (40) competitive advantages, or for evaluating the prospective customer's (20) purchasing criteria. The competition evaluation guide (800) may provide a framework for assessing the competitor (40) in a predetermined objective fashion. The competition evaluation guide (800) may have at least one predetermined competitive evaluation criterion (810).

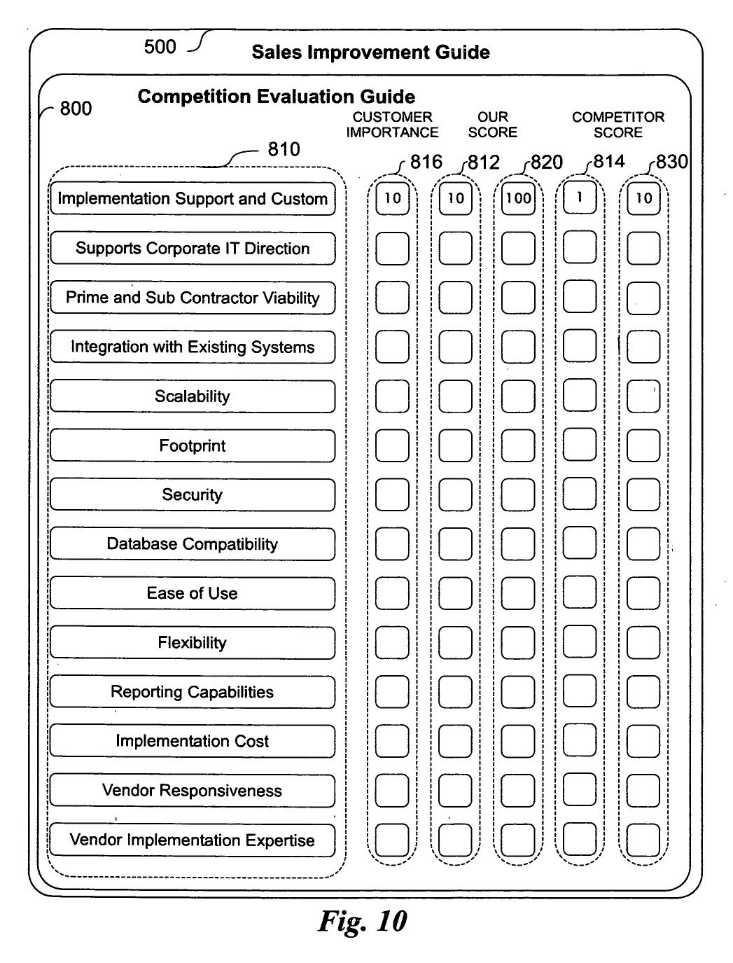

As seen in FIG. 10, a customer importance factor (816) may be assigned to each of the predetermined competitive evaluation criterion (810). In one embodiment of the present invention, the customer importance factor (816) may be a value or ranking on a scale from “1” to “10” with a “1” being not important to the prospective customer (20) and “10” being very important or critical to the prospective customer (20). By way of example and not limitation, various predetermined competitive evaluation criterion (810) may also be seen in FIG. 10.

In another embodiment of the instant invention, the customer importance factor (816) may help the salesperson identify the prospective customer's (20) purchasing criteria in relation to the salesperson's organization's competitive advantages. By way of example, and as seen in FIG. 10, a numerical assessment (812) may be assigned to each predetermined competitive evaluation criterion (810). The numerical assessment (812) may represent how closely the organization conforms to the customer importance factor (816). As one skilled in the art will observe, the numerical assessment (812) may be a ranking with values on a scale from “1” to “10” with a “10” meaning that the organization conforms to the customer importance factor (816) for that predetermined competitive evaluation criterion (810), and with a “1” meaning that the organization's competitive advantages are not in alignment with the perspective customer's (40) perceived importance of that predetermined competitive evaluation criterion (810).

In another related embodiment of the competition evaluation guide (800), an aggregate assessment (820) may be calculated for each predetermined competitive evaluation criterion (810). As one skilled in the art will observe and appreciate, the aggregate assessment (820) may take into account the customer importance factor (816) and the numerical assessment (812). In one particular embodiment, the aggregate assessment (820) may be a product of the numerical assessment and the customer importance factor (816).

With continued reference to FIG. 10, in another related embodiment of the competition evaluation guide (800), a competition numerical assessment (814) may be assigned for each competitor (40). The competition numerical assessment (814) may represent how well the competitor (40) conforms to the prospective customer's (20) customer importance factor (816) for that predetermined competitive evaluation criterion (810). As one skilled in the art will observe and appreciate, and by way of example only, the competition numerical assessment (814) may be a ranking having a value from “1” to “10” with a “1” indicating that the competitor (40) is not conforming to what the prospective customer (20) perceives is important, and with a “10” indicating that the competitor (40) conforms or is in alignment with the prospective customer's (40) ranking for that predetermined competitive evaluation criterion (810). Similar to the aggregate assessment (820) calculated for each predetermined competitive evaluation criterion (810), a competition aggregate assessment (830) may be calculated from the competition numerical assessment (814) and the customer importance factor (816) for each predetermined competitive evaluation criterion (810). In one particular embodiment, the competition aggregate assessment (830) is a product of the customer importance factor (816) and the competition numerical assessment (814). As one skilled in the art will observe and appreciate, having the customer importance factor (816), the numerical assessment (812), and the competition numerical assessment (814) may help the salesperson identify the predetermined competitive evaluation criterion (810) that should be focused on to improve the position with respect to the competitor (40).

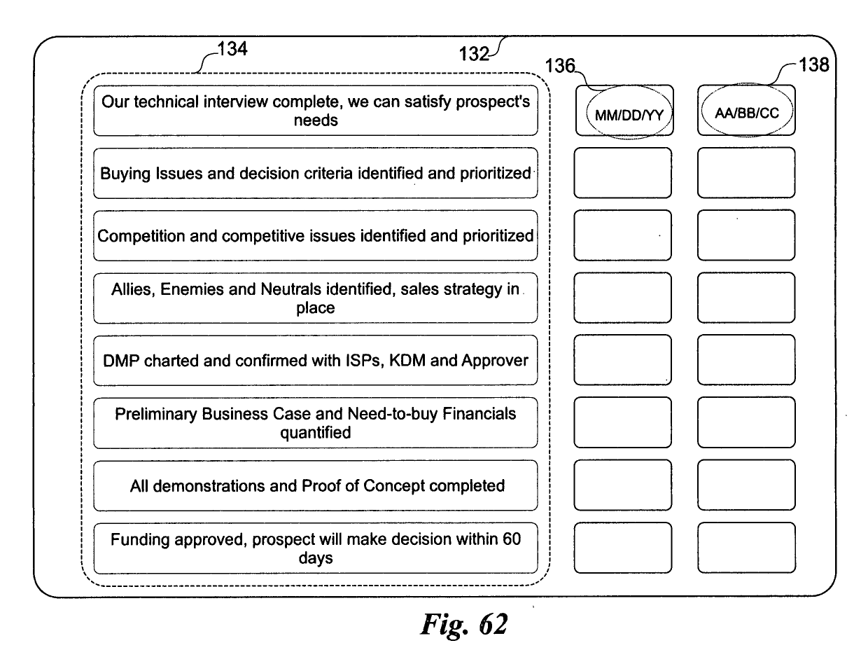

In another embodiment of the instant invention, the third stage (130) is fully addressed after the second stage status (121) is complete, as seen in FIG. 6. Like the initial stage (110) and the second stage (120), the third stage (130) has a third stage status which determines when the third stage is complete. By way of example and not limitation, the third stage (130) may also have a third stage task list (132), as seen in FIG. 62, comprised of at least one third stage required action (134). Each third stage required action (134) may have a third stage required action target completion date (136) and may have a third stage required action actual completion date (138).

Similar to the initial stage (110) and the second stage (120), when the third stage status is incomplete, the sales evaluation guide (200) may have the predetermined sales evaluation criterion (202). The salesperson may select a third stage response from at least one primary third stage ranking and at least one secondary third stage ranking. In another embodiment of the instant invention, the primary third stage ranking may have a primary third stage ranking score. The secondary third stage ranking may have a secondary third stage ranking score, and the third stage response may have a third stage sales score that may be calculated from the secondary third stage ranking score or the primary third stage ranking score depending upon if the salesperson selects the secondary third stage ranking or the primary third stage ranking as the third stage response.

Once the salesperson selects the third stage response, at least one third stage sales improvement objective may be provided. The third stage improvement objective may have a third stage objective completion target date and a third stage objective actual completion date. The salesperson completes the sales improvement guide (500) by performing the third stage improvement objective. Following completion of the sales improvement guide (500), the salesperson updates the third stage task list (132) to determine if the third stage status is complete. If the third stage status is complete, then the salesperson may fully address a fourth stage. As one skilled in the art will observe and appreciate, the predetermined sales evaluation criterion (202), the primary third stage ranking, the secondary third stage ranking, and the third stage improvement objective may be the same as those in the initial stage (110) and the second stage (120).

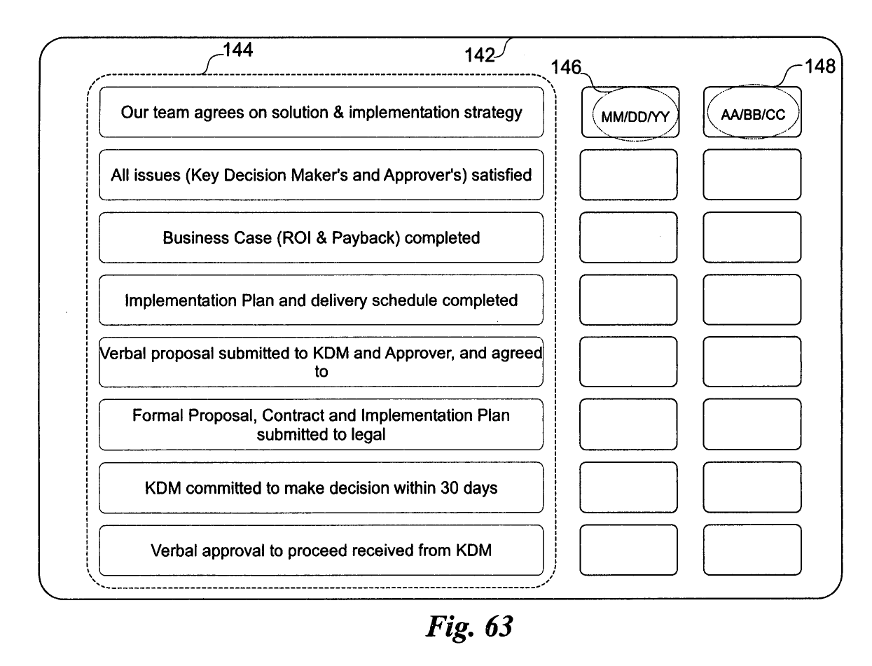

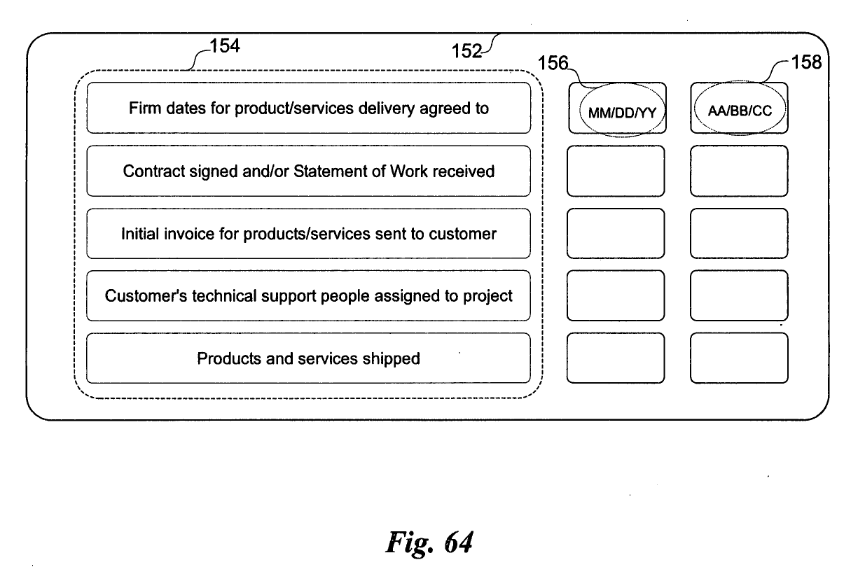

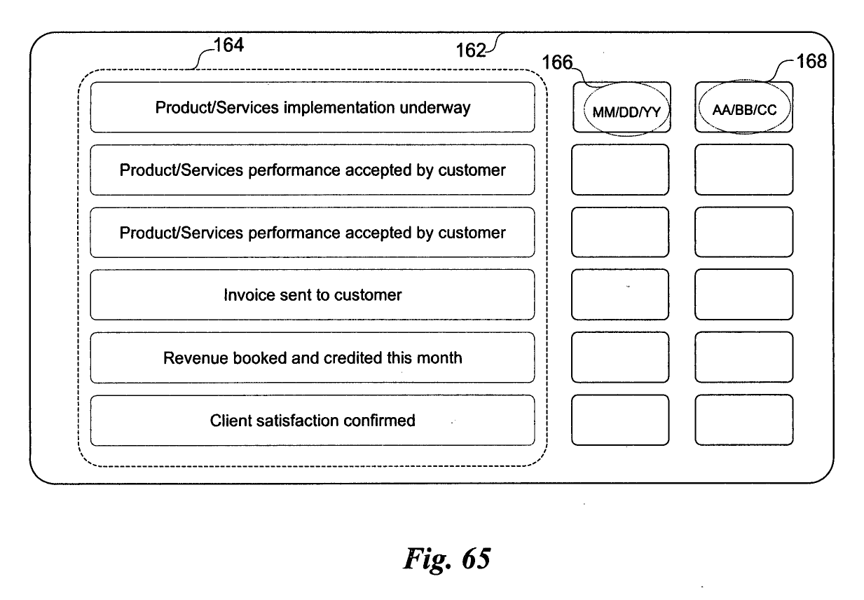

As one skilled in the art will observe and appreciate, the complexity of the sale may be determined by the capital cost of the product or service being sold. Generally, as the cost to the prospective customer (20) increases, the complexity of the selling process may also increase. The method (50) may, therefore, be utilized to provide an objective evaluation of predetermined criterion in both the simple sales and in the most complex selling situations. In one embodiment of the instant invention, in simple selling situations, the method (50) may include multiple simplified stages with a reduced number of required actions per task list. By way of example and not limitation, in a simple sales situation, the progressive sales guide (100) may include three stages (110, 120, 130). Each stage task list (112, 122, 132) may have two required actions (114, 124, 134). In contrast to the simple selling situation, in a more complex selling situation, for example, the progressive sales guide (100) may have six stages with eight or more required actions per stage. In another embodiment of the instant invention, as the complexity of the sales increases, the number of stages may increase and the number of required actions per stage may increase. For instance, following the fourth stage there may be a fifth stage and, possibly, a sixth stage. Each of the stages may have a stage task list, similar to the initial stage (120), by way of example and not limitation, as seen in FIGS. 63, 64, and 65. As one skill in the art will observe and appreciate, similar to the initial stage (110), the initial stage task list (112), and the initial stage required actions (114), each of the subsequent stage task lists and required actions may be customized by the organization. Each stage may have the corresponding sales evaluation guide (200) having predetermined sales evaluation criterion (202) and the corresponding sales improvement guide (500) having improvement objectives.

In another embodiment of the instant invention, a sales meeting development guide may be completed within any one or more of the initial, second, third, fourth, fifth, or sixth stages (110, 120, 130). The sales meeting development guide may help the salesperson plan a sales meeting. Additionally, the sales meeting development guide may help identify the decision makers (710) that should be invited to the sales meeting so that the salesperson may target limited resources on the decision makers (710) that either make the final decision or have influence on other decision makers (710) who do make the final decision.

As one skilled in the art will observe and appreciate, the decision making hierarchy evaluation guide (700), the competition evaluation guide (800), and the sales meeting development guide may be utilized during each of the initial, second, third, fourth, fifth, and sixth stages (1 10, 120, 130). In another embodiment of the instant invention, the decision making hierarchy evaluation guide (700) may not be used at any stage. Likewise, the competition evaluation guide (800) and the sales meeting development guide may not be used at any stage. Each of the hierarchy evaluation guide (700), the competition evaluation guide (800) and the sales meeting development guide may be independently utilized during any stage by the salesperson to improve the probability of making the sale. Finally, as one skilled in the art will observe and appreciate, the method for customized objective predetermined organized selling (50) may be readily adapted to software for use on a personal computer or computer system.

Numerous alterations, modifications, and variations of the preferred embodiments disclosed herein will be apparent to those skilled in the art and they are all anticipated and contemplated to be within the spirit and scope of the instant invention. For example, although specific embodiments have been described in detail, those with skill in the art will understand that the preceding embodiments and variations can be modified to incorporate various types of substitute and or additional or alternative guides, relative arrangement of stages, and configurations. Accordingly, even though only few variations of the present invention are described herein, it is to be understood that the practice of such additional modifications and variations and the equivalents thereof, are within the spirit and scope of the invention as defined in the following claims.

We claim:

1. A method for customized objective predetermined organized selling (50) of a product to a prospective customer (20), comprising the steps of:
(A) initiating a progressive sales guide (100), the progressive sales guide (100) having at least an initial stage (110), wherein the initial stage (110) is substantially described by an initial stage status (111), and the initial stage (110) has an initial stage task list (112) having at least one initial stage required action (114);
(B) determining if the initial stage status (111) is incomplete by verifying if one of the initial stage required actions (114) is incomplete;
(C) completing a sales evaluation guide (200) having at least one predetermined sales evaluation criterion (202) by selecting an initial stage response (210) from a primary initial stage ranking (300) and a secondary initial stage ranking (400), wherein the primary initial stage ranking (300) has a primary initial stage ranking score (302), the secondary initial stage ranking (400) has a secondary initial stage ranking score (402), and the initial stage response (210) has a initial stage sales score (212) that is substantially related to one of the primary initial stage ranking score (302) and the secondary initial stage ranking score (402);
(D) completing a sales improvement guide (500) by performing at least one initial stage improvement objective (600) related to the initial stage response (210); and
(E) determining if the initial stage status (111) is complete by verifying that each of the initial stage required actions (114) is complete.

2. The method for customized objective predetermine organized selling (50) of claim 1, further including
(A) fully addressing a second stage (120) after determining that the initial stage status (111) is complete, the second stage (120) is substantially described by a second stage status (121) and the second stage (120) has a second stage task list (122), wherein the second stage task list (122) has at least one second stage required action (124);
(B) determining if the second stage status (121) is incomplete by verifying if one of the second stage required actions (124) is incomplete;
(C) updating the sales evaluation guide (200) having the predetermined sales evaluation criterion (202) by selecting a second stage response (220) from a primary second stage ranking (310) and a secondary second stage ranking (410), wherein the primary second stage ranking (310) has a primary second stage ranking score (312), the secondary second stage ranking (410) has a secondary second stage ranking score (412), and the second stage response (220) has a second stage sales score (222) that is substantially related to one of the primary second stage ranking score (312) and the secondary second stage ranking score (412);
(D) completing the sales improvement guide (500) by performing at least one second stage improvement objective (610) related to the second stage response (220); and
(E) determining if the second stage status (121) is complete by verifying that each of the second stage required actions (124) is complete.

3. The method for customized objective predetermined organized selling (50) of claim 1, wherein the initial sales score (212) is related to a probability of selling the product to the prospective customer (20).

4. The method for customized objective predetermined organized selling (50) of claim 2, wherein when the second stage response (220) is identical to the initial stage response (210), the second stage sales score (222) is less than the initial sales score (212).

5. The method for customized objective predetermined organized selling (50) of claim 4, wherein when the second stage response (220) is identical to the initial stage response (210), the second stage sales score (222) is equal to the initial sales score (212).

6. The method for customized objective predetermined organized selling (50) of claim 1, wherein the step of completing the sales improvement guide (500) further includes completing a decision making hierarchy evaluation guide (700) for evaluating at least one decision maker (710).

7. The method for customized objective predetermined organized selling (50) of claim 6, wherein during completion of the sales improvement guide (200) at least one of the predetermined sales evaluation criterion (202) is related to completing the decision making hierarchy evaluation guide (700).

8. The method for customized objective predetermined organized selling (50) of claim 7, wherein during completion of the decision making hierarchy evaluation guide (700) at least one predetermined character trait (712) is selected for the decision maker (710).

9. The method for customized objective predetermined organized selling (50) of claim 7, wherein during completion of the decision making hierarchy evaluation guide (700) a decision maker influencer value (714) is selected for the decision maker (710).

10. The method for customized objective predetermined organized selling (50) of claim 7, wherein during completion of the decision making hierarchy evaluation guide (700) a decision maker influenced value (716) is selected for the decision maker (710).

11. The method for customized objective predetermined organized selling (50) of claim 1, wherein the step of completing the sales improvement guide (500) further includes
completing a competition evaluation guide (800) for evaluating the prospective customer (20), by assessing at least one predetermined competitive evaluation criterion (810), by assigning a customer importance factor (816) to each of the predetermined competitive evaluation criterion (810).

12. The method for customized objective predetermined organized selling (50) of claim 11, wherein the step of completing the competition evaluation guide (800), further includes
(i) assessing at least one predetermined competitive evaluation criterion (810), by assigning a numerical assessment (812) to each of the predetermined competitive evaluation criterion (810); and
(ii) calculating an aggregate assessment (820) for each predetermined competitive evaluation criterion (810) from the numerical assessment (812) and the customer importance factor (816) for that predetermined competitive evaluation criterion (810).

13. The method for customized objective predetermined organized selling (50) of claim 11, wherein the step of completing the competition evaluation guide (800), further includes evaluating a competitor (40), by
(i) assessing at least one predetermined competitive evaluation criterion (810), by assigning a competition numerical assessment (814) to each of the predetermined competitive evaluation criterion (810) for the competitor (40); and
(ii) calculating a competition aggregate assessment (830) from the competition numerical assessment (814) and the customer importance factor (816) for that predetermined competitive evaluation criterion (810).

14. A method for customized objective predetermined organized selling (50) of a product to a prospective customer (20), comprising the steps of:
(A) initiating a progressive sales guide (100), the progressive sales guide (100) having at least an initial stage (110), wherein the initial stage (110) is substantially described by an initial stage status (111), and the initial stage (110) has an initial stage task list (112) having at least one initial stage required action (114);
(B) determining if the initial stage status (111) is incomplete by verifying if one of the initial stage required actions (114) is incomplete;
(C) completing a sales evaluation guide (200) having at least one predetermined sales evaluation criterion (202) by selecting an initial stage response (210) from a primary initial stage ranking (300) and a secondary initial stage ranking (400), wherein the primary initial stage ranking (300) has a primary initial stage ranking score (302), the secondary initial stage ranking (400) has a secondary initial stage ranking score (402), the initial stage response (210) has a initial stage sales score (212) that is substantially related to one of the primary initial stage ranking score (302) and the secondary initial stage ranking score (402), and the initial sales score (212) is related to a probability of selling the product to the prospective customer (20);
(D) completing a sales improvement guide (500) by
(i) performing at least one initial stage improvement objective (600) related to the initial stage response (210), and
(ii) completing a decision making hierarchy evaluation guide (700) that evaluates at least one decision maker (710) and where at least one of the predetermined sales evaluation criterion (202) is related to completion of the decision making hierarchy evaluation guide (700); and.
(E) determining if the initial stage status (111) is complete by verifying that each of the initial stage required actions (114) is complete.

15. The method for customized objective predetermine organized selling (50) of claim 14, further including
(A) fully addressing a second stage (120) after determining that the initial stage status (111) is complete, the second stage (120) is substantially described by a second stage status (121) and a second stage task list (122), wherein the second stage task list (122) has at least one second stage required action (124);
(B) determining if the second stage status (121) is incomplete by verifying if one of the second stage required actions (124) is incomplete;
(C) updating the sales evaluation guide (200) having the predetermined sales evaluation criterion (202) by selecting a second stage response (220) from a primary second stage ranking (310) and a secondary second stage ranking (410), wherein the primary second stage ranking (310) has a primary second stage ranking score (312), the secondary second stage ranking (410) has a secondary second stage ranking score (412), and the second stage response (220) has a second stage sales score (222) that is substantially related to one of the primary second stage ranking score (312) and the secondary second stage ranking score (412);
(D) completing the sales improvement guide (500) by performing at least one second stage improvement objective (610) related to the second stage response (220); and
(E) determining if the second stage status (121) is complete by verifying that each of the second stage required actions (124) is complete.

16. The method for customized objective predetermined organized selling (50) of claim 15, wherein when the second stage response (220) is identical to the initial stage response (210), the second stage sales score (222) is less than the initial sales score (212).

17. The method for customized objective predetermined organized selling (50) of claim 16, wherein when the second stage response (220) is identical to the initial stage response (210), the second stage sales score (222) is equal to the initial sales score (212).

18. The method for customized objective predetermined organized selling (50) of claim 14, wherein during completion of the decision making hierarchy evaluation guide (700) at least one predetermined character trait (712) is selected for the decision maker (710).

19. The method for customized objective predetermined organized selling (50) of claim 14, wherein during completion of the decision making hierarchy evaluation guide (700) a decision maker influencer value (714) is selected for the decision maker (710).

20. The method for customized objective predetermined organized selling (50) of claim 14, wherein during completion of the decision making hierarchy evaluation guide (700) a decision maker influenced value (716) is selected for the decision maker (710).

21. The method for customized objective predetermined organized selling (50) of claim 14, wherein the step of completing the sales improvement guide (500) further includes completing a competition evaluation guide (800) for evaluating a competitor (40), by
(i) assessing at least one predetermined competitive evaluation criterion (810), by assigning a numerical assessment (812) to each of the predetermined competitive evaluation criterion (810), and assigning a competition numerical assessment (814) to each of the predetermined competitive evaluation criterion (810) for the competitor (40); and
(ii) calculating an aggregate assessment (820) from each numerical assessment (812), and calculating a competition aggregate assessment (830) from each competition numerical assessment (814).

22. A method for customized objective predetermined organized selling (50) of a product to a prospective customer (20), comprising the steps of:
(A) initiating a progressive sales guide (100), the progressive sales guide (100) having at least an initial stage (110), wherein the initial stage (110) is substantially described by an initial stage status (111), and the initial stage (110) has an initial stage task list (112) having at least one initial stage required action (114);
(B) determining if the initial stage status (111) is incomplete by verifying if one of the initial stage required actions (114) is incomplete;
(C) completing a sales evaluation guide (200) having at least one predetermined sales evaluation criterion (202) by selecting an initial stage response (210) from a primary initial stage ranking (300) and a secondary initial stage ranking (400), wherein the primary initial stage ranking (300) has a primary initial stage ranking score (302), the secondary initial stage ranking (400) has a secondary initial stage ranking score (402), the initial stage response (210) has a initial stage sales score (212) that is substantially related to one of the primary initial stage ranking score (302) and the secondary initial stage ranking score (402), and the initial sales score (212) is related to a probability of selling the product to the prospective customer (20);
(D) completing a sales improvement guide (500) by
(i) performing at least one initial stage improvement objective (600) related to the initial stage response (210);
(ii) completing a decision making hierarchy evaluation guide (700) for evaluating at least one decision maker (710) where at least one of the predetermined sales evaluation criterion (202) is related to completing the decision making hierarchy evaluation guide (700), and during the completion of the decision making hierarchy evaluation guide (700) at least one predetermined character trait (712), a decision maker influencer value (714), and a decision maker influenced value (716) is selected;
(iii) completing a competition evaluation guide (800) for evaluation of a competitor (40), by
(a) assessing at least one predetermined competitive evaluation criterion (810), by assigning a numerical assessment (812) to each of the predetermined competitive evaluation criterion (810), and assigning a competition numerical assessment (814) to each of the predetermined competitive evaluation criterion (810) for the competitor (40); and
(b) calculating an aggregate assessment (820) from each numerical assessment (812), and calculating a competition aggregate assessment (830) from each competition numerical assessment (814);
(E) determining if the initial stage status (111) is complete by verifying that each of the initial stage required actions (114) is complete;
(F) fully addressing a second stage (120) that is substantially described by a second stage status (121) and a second stage task list (122), wherein the second stage task list (122) has at least one second stage required action (124);
(G) determining if the second stage status (121) is incomplete by verifying if one of the second stage required actions (124) is incomplete;
(H) updating the sales evaluation guide (200) having the predetermined sales evaluation criterion (202) by selecting a second stage response (220) from a primary second stage ranking (310) and a secondary second stage ranking (410), wherein the primary second stage ranking (310) has a primary second stage ranking score (312), the secondary second stage ranking (410) has a secondary second stage ranking score (412), and the second stage response (220) has a second stage sales score (222) that is substantially related to one of the primary second stage ranking score (312) and the secondary second stage ranking score (412);
(I) completing the sales improvement guide (500) by
(i) performing at least one second stage improvement objective (610) related to the initial stage response (210);
(ii) updating the decision making hierarchy evaluation guide (700) for including the decision maker (710) where the predetermined sales evaluation criterion (202) is related to completing the decision making hierarchy evaluation guide (700), and during the completion of the decision making hierarchy evaluation guide (700) the at least one predetermined character trait (712), the decision maker influencer value (714), and the decision maker influenced value (716) is selected;
(iii) updating the competition evaluation guide (800) for evaluation of the competitor (40), by
(a) assessing the predetermined competitive evaluation criterion (810), by updating the numerical assessment (812) to the predetermined competitive evaluation criterion (810), and updating the competition numerical assessment (814) to the predetermined competitive evaluation criterion (810) for the competitor (40); and
(b) calculating an aggregate assessment (820) from each numerical assessment (812), and calculating the competition aggregate assessment (830) from each competition numerical assessment (814); and
(J) determining if the second stage status (121) is complete by verifying that each of the second stage required actions (124) is complete.
